(19) United States
(12) Patent Application Publication
(10) Pub. No.: US 2011/0243462 A1
(43) Pub. Date: Oct. 6, 2011

(54) COEFFICIENT LEARNING APPARATUS AND METHOD, IMAGE PROCESSING APPARATUS AND METHOD, PROGRAM, AND RECORDING MEDIUM

(75) Inventors: Takahiro Nagano, Kanagawa (JP); Noriaki Takahashi, Tokyo (JP); Keisuke Chida, Tokyo (JP)

(73) Assignee: Sony Corporation, Tokyo (JP)

(21) Appl. No.: 13/069,489

(22) Filed: Mar. 23, 2011

(30) Foreign Application Priority Data
Mar. 31, 2010 (JP) 2010-081325

(51) Int. Cl. G06K 9/62

(52) U.S. Cl. 382/224

(57) ABSTRACT

A coefficient learning apparatus includes a regression coefficient calculation unit for calculating a regression coefficient, a regression prediction value calculation unit for calculating a regression prediction value, a discrimination information assigning unit for assigning discrimination information for discriminating whether a target pixel belongs to a first discrimination class or a second discrimination class, a discrimination coefficient calculation unit for calculating a discrimination coefficient, a discrimination prediction value calculation unit for calculating a discrimination prediction value, and a classification unit for classifying the pixels of the image of the first signal into any one of the first discrimination class and the second discrimination class based on the calculated discrimination prediction value. The regression coefficient calculation unit further calculates the regression coefficient using only the pixels classified into the first discrimination class and calculates the regression coefficient using only the pixels classified into the second discrimination class.

### BACKGROUND OF THE INVENTION

1. Field of the Invention

The present invention relates to a coefficient learning apparatus and method, an image processing apparatus and method, a program, and a recording medium and, more particularly, to a coefficient learning apparatus and method, an image processing apparatus and method, a program, and a recording medium, which are capable of adaptively improving resolution/sharpness according to the image qualities of various input signals so as to improve image quality at low cost.

2. Description of the Related Art

Recently, image signals have been diversified and thus various bands are mixed regardless of image format. For example, an image having an HD size may be obtained by up-converting an SD image. Such an image may be an image with a less detailed impression, because the bandwidth of the detail of the image is small unlike the original HD image.

Various levels of noise may be included in the image.

In order to predict an image without noise from an input image including deterioration such as noise or convert an SD signal to a high-resolution HD signal, a method using a classification adaptation process is proposed (for example, see Japanese Unexamined Patent Application Publication No. 7-79418)

If an SD signal is converted into an HD signal by the technique of Japanese Unexamined Patent Application Publication No. 7-79418), first, the feature of a class tap including an input SD signal is obtained using an Adaptive Dynamic Range Coding (ADRC) or the like and classification is performed based on the obtained feature of the class tap. An operation of prediction coefficient prepared for each class and a prediction tap including the input SD signal is performed so as to obtain an HD signal.

The classification is to group high S/N pixels by a pattern of pixel values of low S/N pixels spatially or temporally close to a position of a low S/N image corresponding to a position of a high S/N pixel, a prediction value of which will be obtained, and an adaptation process is to obtain a more suitable prediction coefficient with respect to high S/N pixels belonging to a group for each group (corresponding to the above-described class) and to improve image quality by the prediction coefficient. Thus, fundamentally, the classification is preferably performed by configuring a class tap from more pixels related to the high S/N pixel, the prediction value of which will be obtained.

### SUMMARY OF THE INVENTION

However, in the prediction of a teacher image from a student (input) image including deterioration, precision is problematic when a full screen is processed by one model represented by linearization of the student (input) image. For example, in the case of predicting an image in which resolution/sharpness of the input image is improved by the classification adaptation process, in order to cope with various input signals, it is necessary to change a process according to a band or type (natural image/artificial image) of an image or noise amount.

However, in this case, it is necessary to take into account extensive patterns and it is difficult to cover all cases. Thus, the resolution/sharpness of the image which may be obtained as the result of performing the prediction process may not be improved. On the contrary, the process is extremely strong such that ringing deterioration or noise may be emphasized.

It is desirable to adaptively improve resolution/sharpness according to the image qualities of various input signals so as to improve the image qualities at low cost.

According to an embodiment of the present invention, there is provided a coefficient learning apparatus including: a regression coefficient calculation means for acquiring a regression tap configured as a plurality of filter operation values for extracting a frequency band of a variation in pixel values of a target pixel and a peripheral pixel from an image of a first signal and calculating a regression coefficient of a regression prediction operation for obtaining the pixel value corresponding to the target pixel in an image of a second signal by an operation of the regression tap and the regression coefficient; a regression prediction value calculation means for performing the regression prediction operation based on the calculated regression coefficient and the regression tap obtained from the image of the first signal and calculating a regression prediction value; a discrimination information assigning means for assigning discrimination information for discriminating whether the target pixel belongs to a first discrimination class or a second discrimination class based on a result of comparing the calculated regression prediction value and the pixel value corresponding to the target pixel in the image of the second signal; a discrimination coefficient calculation means for acquiring a discrimination tap including a plurality of feature amounts as elements based on the pixel value of the peripheral pixel and a plurality of filter operation values for extracting the frequency band of the variation in pixel values of the target pixel and the peripheral pixel from the image of the first signal based on the assigned discrimination information and calculating the discrimination coefficient of a discrimination prediction operation for obtaining a discrimination prediction value for specifying a discrimination class, to which the target pixel belongs, by a product-sum operation of each of the elements of the discrimination tap and the discrimination coefficient; a discrimination prediction value calculation means for performing the discrimination prediction operation based on the discrimination tap obtained from the image of the first signal and the calculated discrimination coefficient and calculating a discrimination prediction value; and a classification means for classifying the pixels of the image of the first signal into any one of the first discrimination class and the second discrimination class based on the calculated discrimination prediction value, wherein the regression coefficient calculation means further calculates the regression coefficient using only the pixels classified into the first discrimination class and calculates the regression coefficient using only the pixels classified into the second discrimination class.

A process of assigning the discrimination information by the discrimination information assigning means, a process of calculating the discrimination coefficient by the discrimination coefficient calculation means and a process of calculating the discrimination prediction value by the discrimination prediction value calculation means may be repeatedly executed based on the regression prediction value calculated for each discrimination class by the regression prediction value calculation means and by the regression coefficient calculated for each discrimination class by the regression coefficient calculation means.

If a difference between the regression prediction value and the pixel value corresponding to the target pixel in the image of the second signal is equal to or greater than 0, it may be determined that the target pixel belongs to the first discrimination class, and, if the difference between the regression prediction value and the pixel value corresponding to the target pixel in the image of the second signal is less than 0, it may be determined that the target pixel belongs to the first discrimination class.

If an absolute value of a difference between the regression prediction value and the pixel value corresponding to the target pixel in the image of the second signal is equal to or greater than a predetermined threshold value, it may be determined that the target pixel belongs to the first discrimination class, and, if the absolute value of the difference between the regression prediction value and the pixel value corresponding to the target pixel in the image of the second signal is less than a predetermined threshold value, it may be determined that the target pixel belongs to the second discrimination class.

The image of the first signal may be an image in which the frequency band of the variation in pixel value is limited and predetermined noise is applied to the image of the second signal.

The image of the second signal may be a natural image or an artificial image.

The plurality of feature amounts based on the pixel value of the peripheral pixel included in the discrimination tap may be a maximum value of a peripheral pixel value, a minimum value of a peripheral pixel value and a maximum value of a difference absolute value of a peripheral pixel value.

According to an embodiment of the present invention, there is provided a coefficient learning method including the steps of: causing a regression coefficient calculation means to acquire a regression tap configured as a plurality of filter operation values for extracting a frequency band of a variation in pixel values of a target pixel and a peripheral pixel from an image of a first signal and to calculate a regression coefficient of a regression prediction operation for obtaining the pixel value corresponding to the target pixel in an image of a second signal by an operation of the regression tap and the regression coefficient; causing a regression prediction value calculation means to perform the regression prediction operation based on the calculated regression coefficient and the regression tap obtained from the image of the first signal and to calculate a regression prediction value; causing a discrimination information assigning means to assign discrimination information for discriminating whether the target pixel belongs to a first discrimination class or a second discrimination class based on a result of comparing the calculated regression prediction value and the pixel value corresponding to the target pixel in the image of the second signal; causing a discrimination coefficient calculation means to acquire a discrimination tap including a plurality of feature amounts as elements based on the pixel value of the peripheral pixel and a plurality of filter operation values for extracting the frequency band of the variation in pixel values of the target pixel and the peripheral pixel from the image of the first signal based on the assigned discrimination information and calculating the discrimination coefficient of a discrimination prediction operation for obtaining a discrimination prediction value for specifying a discrimination class, to which the target pixel belongs, by a product-sum operation of each of the elements of the discrimination tap and the discrimination coefficient; causing a discrimination prediction value calculation means to perform the discrimination prediction operation based on the discrimination tap obtained from the image of the first signal and the calculated discrimination coefficient and to calculate a discrimination prediction value; causing a classification means to classify the pixels of the image of the first signal into any one of the first discrimination class and the second discrimination class based on the calculated discrimination prediction value; and further calculating the regression coefficient using only the pixels classified into the first discrimination class and calculating the regression coefficient using only the pixels classified into the second discrimination class.

According to an embodiment of the present invention, there is provided a program for causing a computer to function as a coefficient learning apparatus including: a regression coefficient calculation means for acquiring a regression tap configured as a plurality of filter operation values for extracting a frequency band of a variation in pixel values of a target pixel and a peripheral pixel from an image of a first signal and calculating a regression coefficient of a regression prediction operation for obtaining the pixel value corresponding to the target pixel in an image of a second signal by an operation of the regression tap and the regression coefficient; a regression prediction value calculation means for performing the regression prediction operation based on the calculated regression coefficient and the regression tap obtained from the image of the first signal and calculating a regression prediction value; a discrimination information assigning means for assigning discrimination information for discriminating whether the target pixel belongs to a first discrimination class or a second discrimination class based on a result of comparing the calculated regression prediction value and the pixel value corresponding to the target pixel in the image of the second signal; a discrimination coefficient calculation means for acquiring a discrimination tap including a plurality of feature amounts as elements based on the pixel value of the peripheral pixel and a plurality of filter operation values for extracting the frequency band of the variation in pixel values of the target pixel and the peripheral pixel from the image of the first signal based on the assigned discrimination information and calculating the discrimination coefficient of a discrimination prediction operation for obtaining a discrimination prediction value for specifying a discrimination class, to which the target pixel belongs, by a product-sum operation of each of the elements of the discrimination tap and the discrimination coefficient; a discrimination prediction value calculation means for performing the discrimination prediction operation based on the discrimination tap obtained from the image of the first signal and the calculated discrimination coefficient and calculating a discrimination prediction value; and a classification means for classifying the pixels of the image of the first signal into any one of the first discrimination class and the second discrimination class based on the calculated discrimination prediction value, wherein the regression coefficient calculation means further calculates the regression coefficient using only the pixels classified into the first discrimination class and calculates the regression coefficient using only the pixels classified into the second discrimination class.

In the embodiment of the present invention, a regression tap configured as a plurality of filter operation values for extracting a frequency band of a variation in pixel values of a target pixel and a peripheral pixel is acquired from an image of a first signal and a regression coefficient of a regression prediction operation for obtaining the pixel value corresponding to the target pixel in an image of a second signal is calculated by an operation of the regression tap and the regression coefficient; the regression prediction operation is performed based on the calculated regression coefficient and the regression tap obtained from the image of the first signal and a regression prediction value is calculated; discrimination information for discriminating whether the target pixel belongs to a first discrimination class or a second discrimination class is assigned based on a result of comparing the calculated regression prediction value and the pixel value corresponding to the target pixel in the image of the second signal; a discrimination tap including a plurality of feature amounts as elements based on the pixel value of the peripheral pixel and a plurality of filter operation values for extracting the frequency band of the variation in pixel values of the target pixel and the peripheral pixel from the image of the first signal is acquired based on the assigned discrimination information and the discrimination coefficient of a discrimination prediction operation for obtaining a discrimination prediction value for specifying a discrimination class, to which the target pixel belongs, is calculated by a product-sum operation of each of the elements of the discrimination tap and the discrimination coefficient; the discrimination prediction operation is performed based on the discrimination tap obtained from the image of the first signal and the calculated discrimination coefficient and a discrimination prediction value is calculated; and the pixels of the image of the first signal is classified into any one of the first discrimination class and the second discrimination class based on the calculated discrimination prediction value, wherein the regression coefficient is further calculated using only the pixels classified into the first discrimination class and the regression coefficient is further calculated using only the pixels classified into the second discrimination class.

According to another embodiment of the present invention, there is provided an image processing apparatus including: a discrimination prediction unit means for acquiring a regression tap including a plurality of feature amounts as elements based on a plurality of filter operation values for extracting a frequency band of a variation in pixel values of a target pixel and a peripheral pixel from an image of a first signal and the pixel value of the peripheral pixel and performing a discrimination prediction operation for obtaining a discrimination prediction value for specifying a discrimination class to which the target pixel belongs by a product-sum operation of each of the elements of the discrimination tap and the discrimination coefficient; a classification means for classifying the pixels of the image of the first signal into any one of the first discrimination class and the second discrimination class based on the discrimination prediction value; and a regression prediction means for acquiring a regression tap configured as the plurality of filter operation values for extracting the frequency band of the variation in pixel values of the target pixel and the peripheral pixel from the image of the first signal and calculating a regression prediction value by an operation of the regression tap and a regression coefficient so as to predict the pixel value of the pixel corresponding to the target pixel in an image of a second signal.

A process of performing the discrimination prediction operation by the discrimination prediction means and a process of classifying the pixels of the image of the first signal by the classification may be repeatedly executed.

The image of the first signal may be an image in which the frequency band of the variation in pixel value is limited and predetermined noise is applied to the image of the second signal.

The image of the second signal may be a natural image or an artificial image.

The plurality of feature amounts based on the pixel value of the peripheral pixel included in the discrimination tap may be a maximum value of a peripheral pixel value, a minimum value of a peripheral pixel value and a maximum value of a difference absolute value of a peripheral pixel value.

According to another embodiment of the present invention, there is provided an image processing method including the steps of: causing a discrimination prediction unit means to acquire a regression tap including a plurality of feature amounts as elements based on a plurality of filter operation values for extracting a frequency band of a variation in pixel values of a target pixel and a peripheral pixel from an image of a first signal and the pixel value of the peripheral pixel and to perform a discrimination prediction operation for obtaining a discrimination prediction value for specifying a discrimination class to which the target pixel belongs by a product-sum operation of each of the elements of the discrimination tap and the discrimination coefficient; causing a classification means to classify the pixels of the image of the first signal into any one of the first discrimination class and the second discrimination class based on the discrimination prediction value; and causing a regression prediction means to acquire a regression tap configured as the plurality of filter operation values for extracting the frequency band of the variation in pixel values of the target pixel and the peripheral pixel from the image of the first signal and to calculate a regression prediction value by an operation of the regression tap and a regression coefficient so as to predict the pixel value of the pixel corresponding to the target pixel in an image of a second signal.

According to another embodiment of the present invention, there is provided a program for causing a computer to function as an image processing apparatus including: a discrimination prediction unit means for acquiring a regression tap including a plurality of feature amounts as elements based on a plurality of filter operation values for extracting a frequency band of a variation in pixel values of a target pixel and a peripheral pixel from an image of a first signal and the pixel value of the peripheral pixel and performing a discrimination prediction operation for obtaining a discrimination prediction value for specifying a discrimination class to which the target pixel belongs by a product-sum operation of each of the elements of the discrimination tap and the discrimination coefficient; a classification means for classifying the pixels of the image of the first signal into any one of the first discrimination class and the second discrimination class based on the discrimination prediction value; and a regression prediction means for acquiring a regression tap configured as the plurality of filter operation values for extracting the frequency band of the variation in pixel values of the target pixel and the peripheral pixel from the image of the first signal and calculating a regression prediction value by an operation of the regression tap and a regression coefficient so as to predict the pixel value of the pixel corresponding to the target pixel in an image of a second signal.

In the embodiment of the present invention, a regression tap including a plurality of feature amounts as elements based on a plurality of filter operation values for extracting a frequency band of a variation in pixel values of a target pixel and a peripheral pixel is acquired from an image of a first signal and the pixel value of the peripheral pixel and a discrimination prediction operation for obtaining a discrimination prediction value for specifying a discrimination class to which the target pixel belongs is performed by a product-sum operation of each of the elements of the discrimination tap and the discrimination coefficient; the pixels of the image of the first signal are classified into any one of the first discrimination class and the second discrimination class based on the discrimination prediction value; and a regression tap configured as the plurality of filter operation values for extracting the frequency band of the variation in pixel values of the target pixel and the peripheral pixel is acquired from the image of the first signal and a regression prediction value is calculated by an operation of the regression tap and a regression coefficient so as to predict the pixel value of the pixel corresponding to the target pixel in an image of a second signal.

According to the present invention, it is possible to adaptively improve resolution/sharpness according to image quality of various input signals so as to realize image quality improvement with low cost.

### BRIEF DESCRIPTION OF THE DRAWINGS

FIG. 1 is a block diagram showing a configuration example of a learning apparatus according to an embodiment of the present invention;

FIG. 2 is a block diagram showing a configuration example of a learning pair generation apparatus;

FIG. 3 is a diagram illustrating pixels of a student image used to calculate feature amounts;

FIG. 4 is a diagram illustrating a horizontal direction difference absolute value of a peripheral pixel value;

FIG. 5 is a diagram illustrating a vertical direction difference absolute value of a peripheral pixel value;

FIG. 6 is a diagram illustrating a right oblique direction difference absolute value of a peripheral pixel value;

FIG. 7 is a diagram illustrating a left oblique direction difference absolute value of a peripheral pixel value;

FIG. 8 is a histogram illustrating a process of a labeling unit of FIG. 1;

FIG. 9 is a diagram illustrating learning of a discrimination coefficient performed repetitively;

FIG. 10 is a diagram illustrating learning of a discrimination coefficient performed repetitively;

FIG. 11 is a diagram illustrating an example of the case of classifying an input image using a two-branch structure;

FIG. 12 is a block diagram showing a configuration example of an image processing apparatus corresponding to the learning apparatus of FIG. 1;

FIG. 13 is a flowchart illustrating an example of a discrimination coefficient regression coefficient learning process by the learning apparatus of FIG. 1;

FIG. 14 is a flowchart illustrating an example of a labeling process;

FIG. 15 is a flowchart illustrating an example of a regression coefficient operation process;

FIG. 16 is a flowchart illustrating an example of a discrimination coefficient operation process;

FIG. 17 is a flowchart illustrating an example of a discrimination regression prediction process by the image processing apparatus of FIG. 12;

FIG. 18 is a flowchart illustrating an example of a discrimination process;

FIG. 19 is a block diagram showing a configuration example of a television receiver in which the image processing apparatus according to the embodiment of the present invention is mounted; and

FIG. 20 is a block diagram showing a configuration example of a personal computer.

### DESCRIPTION OF THE PREFERRED EMBODIMENTS

Hereinafter, embodiments of the present invention will be described with reference to the accompanying drawings.

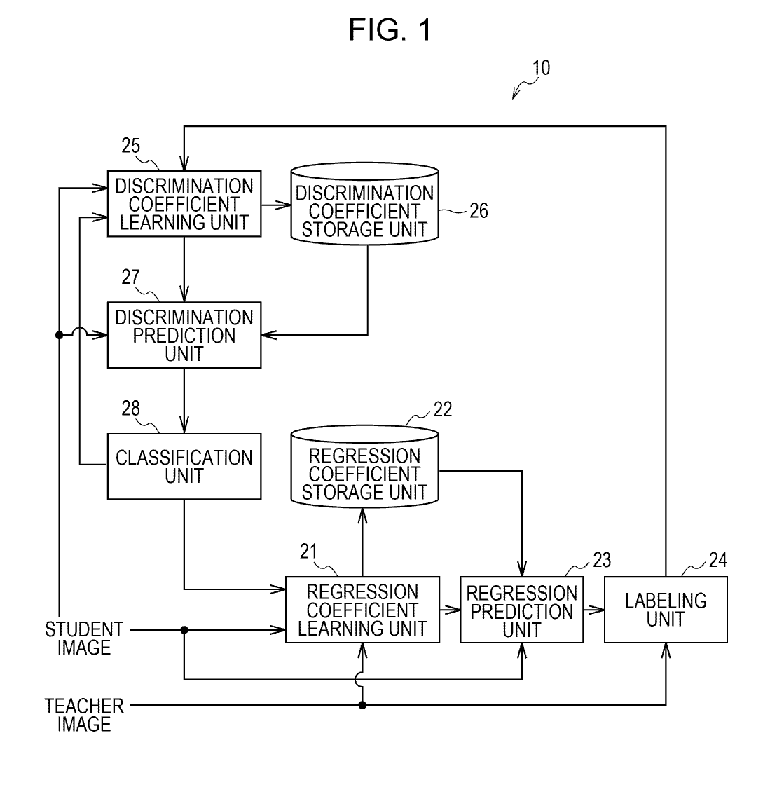

FIG. 1 is a block diagram showing a configuration example of a learning apparatus according to an embodiment of the present invention.

The learning apparatus 10 is used for an image quality improvement process of an image and generates coefficients used for the image quality improvement process based on data of an input student image and teacher image (or teacher signal).

The image quality improvement process generates an image in which resolution/sharpness of an input image is improved and, for example, converts an image having a small band into an image having a large band or removes noise included in an image. In addition, as an input image, an image (referred to as an artificial image) including a CG image may be the input image, a telop or the like, or an image (referred to as a natural image) without telop or the like may be the input image.

The learning apparatus 10 learns a regression coefficient for generating a high-quality image close to a teacher image using a student image as an input image. Although described in detail below, the regression coefficient is used for a linear equation for calculating the pixel value corresponding to target pixel with respect to an image, the image quality of which is improved, using a feature amount obtained from a plurality of pixel values corresponding to the target pixel of the input image as a parameter. The regression coefficient is learned for each class number (described below).

The learning apparatus 10 classifies the target pixel into any one of the plurality of classes based on the feature amount obtained from the plurality of pixel values corresponding to the target pixel of the input image. That is, the learning apparatus 10 learns a discrimination coefficient for specifying to which class for an image quality improvement process each target pixel of the input image belongs. Although described in detail below, the discrimination coefficient is used for a linear equation using a feature amount obtained from the values of the plurality of pixels corresponding to the target pixel of the input image as a parameter.

That is, the operation of the linear equation using the feature amount obtained by the plurality of pixel values corresponding to the target pixel of the input image as the parameter is repeatedly executed using the discrimination coefficient learned by the learning apparatus 10 so as to specify the class for the image quality improvement process. The operation of the linear equation using the feature amount obtained by the plurality of pixel values corresponding to the target pixel of the input image is executed using the regression coefficient corresponding to the specified class so as to calculate the pixel value of the image, the image quality of which is improved.

In the learning apparatus 10, for example, an image without band limitation and noise is input as a teacher image, and an image in which band limitation is added and noise is added to the teacher image is input as a student image. A pair (referred to as a learning pair) of teacher image and student image is input and learned by the learning apparatus 10.

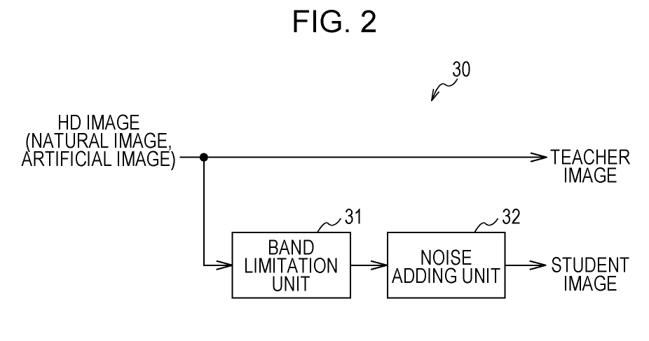

FIG. 2 is a block diagram showing a configuration example of the learning pair generation apparatus 30. As shown in the figure, the learning pair generation apparatus 30 includes a band limitation unit 31 and a noise adding unit 32.

In this example, an HD image of a natural image or an artificial image is input to the learning pair generation apparatus 30 such that the input image is output as the teacher image without change. In contrast, an image obtained by performing the processes of the band limitation unit 31 and the noise adding unit 32 with respect to the input image is output as a student image.

The band limitation unit 31 is a functional block for mainly performing band limitation for reducing the band of the input image. For example, a change in a pixel value of a detail of an input image is reduced by the process of the band limitation unit 31 so as to generate an image with a less detail feeling. That is, a process for reducing a frequency band of a change in pixel value of an image is performed. In addition, the band limitation unit 31 may add, for example, 9 types of band limitations including “non band limitation” so as to obtain 9 outputs with respect to one input image.

The noise adding unit 32 is a functional block for mainly adding various types of noises to the input image. For example, an image, in which block noise, Mosquito noise or the like is added to a part of the input image, is generated by the process of the noise adding unit 32. The noise adding unit 32 may add, for example, 11 types of noises including “no noise” so as to obtain 11 outputs with respect to one input image supplied from the band limitation unit 31.

By the learning pair generation apparatus 30 shown in FIG. 2 may obtain, for example, 99 (=9×11) outputs with respect to one input image. However, since 1 output corresponds to “no band limitation” and “no noise” and is the same image as the input image, a total of 98 learning pairs is generated from 1 input image by the learning pair generation apparatus 30.

For example, a plurality of images including a natural image and an artificial image is supplied to the learning pair generation apparatus 30 so as to generate the learning pairs as described above. The generated learning pairs are supplied to the learning apparatus 10 of FIG. 1 as the student image and the teacher image.

Returning to FIG. 1, the data of the student image is supplied to a regression coefficient learning unit 21, a regression prediction unit 23, a discrimination coefficient learning unit 25 and a discrimination prediction unit 27.

The regression coefficient learning unit 21 sets a predetermined pixel among pixels configuring the student image as the target pixel. The regression coefficient learning unit 21 learns a coefficient of a regression prediction operation equation for predicting teacher image pixel values corresponding to the target pixel from the pixel values of the target pixel of the student image and the periphery thereof, for example, using a least squares method.

Although described in detail below, in the present invention, in the above-described regression prediction operation, it is assumed that a prediction value is a linear model using the regression coefficient learned by the learning apparatus 10. At this time, the regression prediction operation, the feature amount obtained from the plurality of pixel values corresponding to the target pixel of the input image as is given as the parameter. In the present invention, even in the linear equation operation (discrimination prediction operation) using the above-described discrimination coefficient, the feature amount obtained from the plurality of pixel values corresponding to the target pixel of the input image is given as the parameter. In the present invention, this parameter includes 5 feature amounts obtained from the plurality of pixel values corresponding to the target pixel of the input image. As described above, in the regression prediction operation, 2 feature amounts among 5 feature amounts obtained from the plurality of pixel values corresponding to the target pixel of the input image are used.

The above-described 5 feature amounts include a high-pass filter operation value, a low-pass filter operation value, a maximum value of a peripheral pixel value, a minimum value of a peripheral pixel value, and a maximum value of a difference absolute value of a peripheral pixel value.

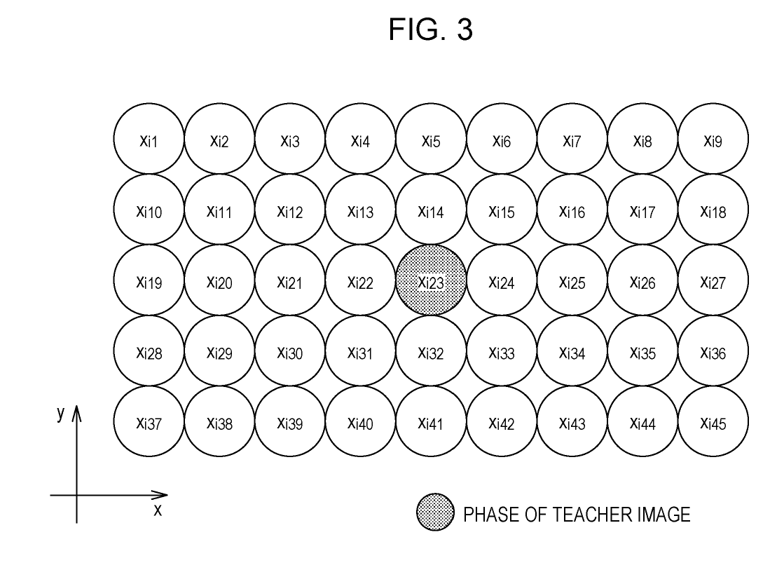

FIG. 3 is a diagram illustrating pixels of a student image used to calculate the above-described 5 feature amounts. In this example, the pixels of the student image is expressed by circles of 5 rows and 9 columns (=45) arranged on an xy plane and a symbol including “x” and “in (n=1, 2, . . . , 45) are attached to each pixel. The target pixel corresponding to the phase (coordinate) of the pixel of the teacher image, the pixel value of which is predicted, is a pixel (a circle to which a symbol of “i23” is attached) of a third row and a fifth row of the figure. The symbol attached to the circle of the figure identifies each pixel and is used as the pixel value of each pixel.

A high-pass filter operation value and a low-pass filter operation value which correspond to first and second feature amounts among the above-described 5 feature amounts extract information about the frequency band of a change in pixel value of the target pixel and the peripheral pixel thereof. The operation is performed by Equation 1.

$$\begin{matrix}Equation 1 & \\ {x}_{i}^{t 1} = {v}_{1}^{t 1} \cdot {x}_{i 23} + {v}_{2}^{t 1} \cdot ( {x}_{i 14} + {x}_{i 22} + {x}_{i 24} + {x}_{i 32} ) + {v}_{3}^{t 1} \cdot ( {x}_{i 5} + {x}_{i 21} + {x}_{i 25} + {x}_{i 41} ) + {v}_{4}^{t 1} \cdot ( {x}_{i 13} + {x}_{i 15} + {x}_{i 31} + {x}_{i 33} ) + {v}_{5}^{t 1} \cdot ( {x}_{i 3} + {x}_{i 7} + {x}_{i 39} + {x}_{i 43} ) + {v}_{6}^{t 1} \cdot ( {x}_{i 4} + {x}_{i 6} + {x}_{i 12} + {x}_{i 16} + {x}_{i 30} + {x}_{i 34} + {x}_{i 40} + {x}_{i 42} ) \\ {x}_{i}^{t 2} = {v}_{1}^{t 2} \cdot {x}_{i 23} + {v}_{2}^{t 2} \cdot ( {x}_{i 14} + {x}_{i 22} + {x}_{i 24} + {x}_{i 32} ) + {v}_{3}^{t 2} \cdot ( {x}_{i 5} + {x}_{i 21} + {x}_{i 25} + {x}_{i 41} ) + {v}_{4}^{t 2} \cdot ( {x}_{i 13} + {x}_{i 15} + {x}_{i 31} + {x}_{i 33} ) + {v}_{5}^{t 2} \cdot ( {x}_{i 3} + {x}_{i 7} + {x}_{i 39} + {x}_{i 43} ) + {v}_{6}^{t 2} \cdot ( {x}_{i 4} + {x}_{i 6} + {x}_{i 12} + {x}_{i 16} + {x}_{i 30} + {x}_{i 34} + {x}_{i 40} + {x}_{i 42} ) & ( 1 )\end{matrix}$$

v^{t1}=(v₁^{t1}, v₂^{t1}, . . . , v₆^{t1})^{T}, v^{t2}=(v₁^{t2}, v₂^{t2}, . . . , v₆^{t2})^{T} is a filter coefficient.

xᵢ^{t1} obtained by Equation 1 is a high-pass filter operation value and xᵢ^{t2} is a low-pass filter operation value obtained by Equation 1. The filter coefficient is set in advance.

In Equation 1, among the pixels of 5 rows and 9 columns shown in FIG. 3, the pixel values of 25 (5 rows and 5 columns) pixels including third to seventh pixels are used for operation. The pixel values of a plurality of pixels located at the same relative position from the target pixel are multiplied by the same filter coefficient. For example, the pixel values of the pixels, to which the symbols of “i14”, “i22”, “i24” and “i32” are attached, located at the relative position from the target pixel (a circle to which a symbol “i23” is attached) may be multiplied by the same filter coefficient v₂^{t1}.

As expressed by Equation 1, by adding the pixel values multiplied by the same filter coefficient in advance (operation in brackets of the equation), it is possible to reduce the number of filter coefficients and to lessen processing load.

Although the high-pass filter operation value and the low-pass filter operation value are set as the first feature amount, the first feature amount may include other filter operation values.

The maximum value of the peripheral pixel value and the minimum value of the peripheral pixel value which correspond to third and fourth feature amounts among the above-described 5 feature amounts are calculated by Equation 2.

$$\begin{matrix}Equation 2 & \\ {x}_{i}^{( max )} = {max}_{1 \leq j \leq M} {x}_{ij} \\ {x}_{i}^{( min )} = {min}_{1 \leq j \leq M} {x}_{ij} & ( 2 )\end{matrix}$$

xᵢ^{(max)} obtained by Equation 2 is the maximum value of the peripheral pixel value and xᵢ^{(min)} obtained by Equation 2 is the minimum value of the peripheral pixel value.

The maximum value of the difference absolute value of the peripheral pixel value which is the fifth feature amount among the above-described 5 feature amounts is obtained as follows. First, a maximum value of a horizontal direction difference absolute value of a peripheral pixel value, a maximum value of a vertical direction difference absolute value of a peripheral pixel value, a maximum value of a right oblique direction difference absolute value of a peripheral pixel value and a maximum value of a left oblique direction difference absolute value of a peripheral pixel value are obtained.

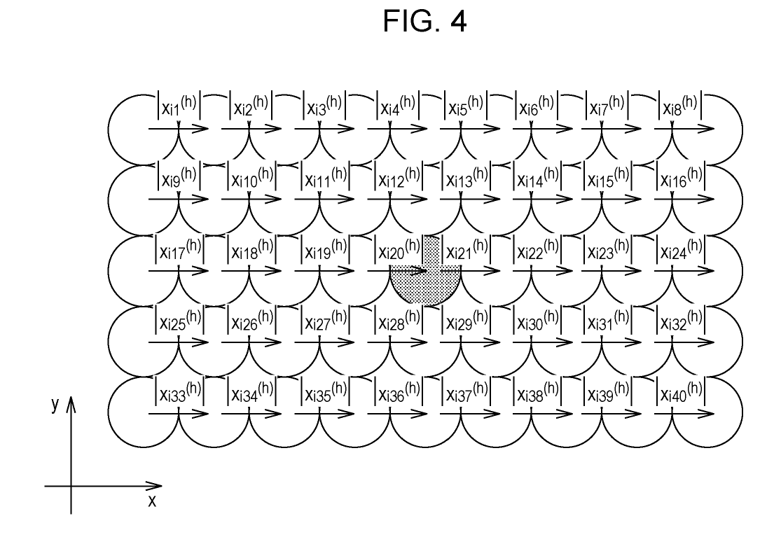

FIG. 4 is a diagram illustrating the horizontal direction difference absolute value of the peripheral pixel value. As shown in the same figure, the difference absolute values of the pixel values respectively adjacent to 45 pixels shown in FIG. 3 in the horizontal direction are calculated. For example, an absolute value of a difference between a pixel value of a pixel to which a symbol “i1” is attached and a pixel value of a pixel to which a symbol “i2” is attached is calculated as |xᵢ₁^{h}|.

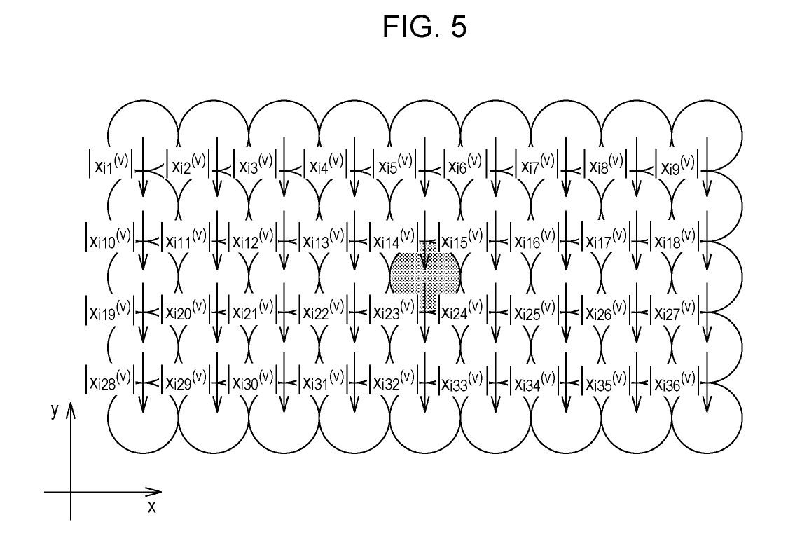

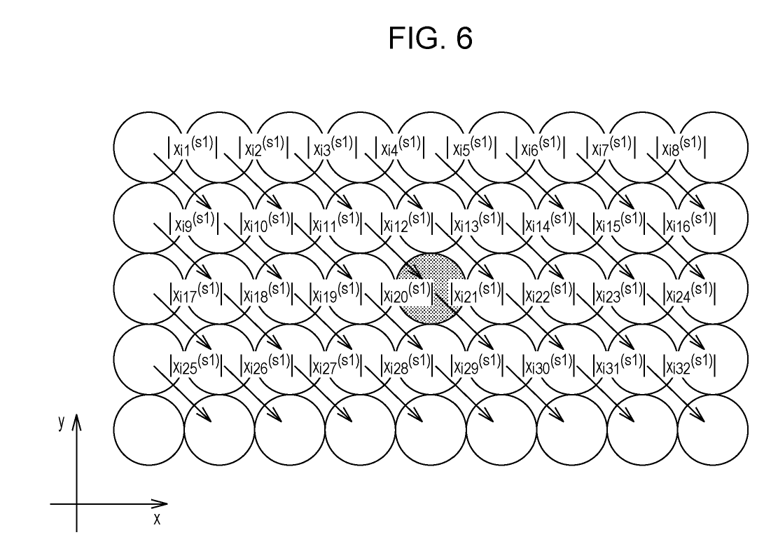

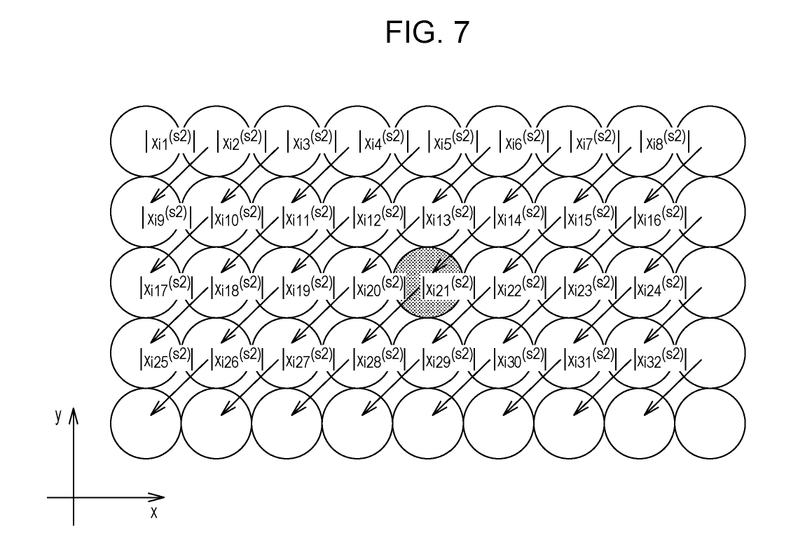

Similarly, the vertical direction difference absolute value of the peripheral pixel value is calculated as shown in FIG. 5. The right oblique direction difference absolute value of the peripheral pixel value and the left oblique direction difference absolute value of the peripheral pixel value are respectively calculated as shown in FIGS. 6 and 7.

Maximum values are obtained by Equation 3 with respect to the horizontal direction difference absolute value, the vertical direction difference absolute value, the right oblique direction difference absolute value and the left oblique direction difference absolute value calculated as described above with reference to FIGS. 4 to 7.

$$\begin{matrix}Equation 3 & \\ {\vert {x}_{i}^{( h )} \vert}^{( max )} = {max}_{1 \leq j \leq O} \vert {x}_{ij}^{( h )} \vert \\ {\vert {x}_{i}^{( v )} \vert}^{( max )} = {max}_{1 \leq j \leq P} \vert {x}_{ij}^{( v )} \vert \\ {\vert {x}_{i}^{( s 1 )} \vert}^{( max )} = {max}_{1 \leq j \leq Q} \vert {x}_{ij}^{( s 1 )} \vert \\ {\vert {x}_{i}^{( s 2 )} \vert}^{( max )} = {max}_{1 \leq j \leq Q} \vert {x}_{ij}^{( s 2 )} \vert & ( 3 )\end{matrix}$$

|xᵢ^{(h)}|^{(max)} of Equation 3 is the maximum value of the horizontal direction difference absolute value of the peripheral pixel value. |xᵢ^{(v)}|^{(max)} of Equation 3 is the maximum value of the vertical direction difference absolute value of the peripheral pixel value. |xᵢ^{(s1)}|^{(max)} of Equation 3 is the maximum value of the right oblique direction difference absolute value of the peripheral pixel value. |xᵢ^{(s2)}|^{(max)} of Equation 3 is the maximum value of the left oblique direction difference absolute value of the peripheral pixel value.

Among the four maximum values obtained by Equation 3, a largest value may be obtained by Equation 4.

Equation 4

|xᵢ|^{(max)}=max(|xᵢ^{(h)}|^{(max)},|xᵢ^{(v)}|^{(max)},|xᵢ^{(s1)}|^{(max)},|xᵢ^{(s2)}|^{(max)}) (4)

|xᵢ|^{(max)} becomes the maximum value of the difference absolute value of the peripheral pixel value which is the fifth feature amount.

Next, learning of the above-described regression coefficient will be described. In the regression prediction operation equation for predicting the above-described teacher image pixel value, for example, if the pixel value tᵢ (i=1, 2, . . . , N) of the teacher image is set and the prediction value yᵢ (i=1, 2, . . . , N) is set, Equation 5 is satisfied. Here, N denotes the total number of samples of the pixels of the student image and the pixels of the teacher image.

Equation 5

tᵢ=yᵢ+εᵢ (5)

Here, εᵢ (i=1, 2, . . . , N) is an error term. The prediction value yᵢ may be expressed by Equation 6 using the high-pass filter operation value and the low-pass filter operation value obtained as the pixel values of the student image as the parameters (referred to as taps), if a linear model using a regression coefficient w₀ is assumed.

Equation 6

yᵢ=w₀·(xᵢ^{t1}−xᵢ^{t2})+xᵢ^{t2} (6)

If the coefficient of the regression prediction operation equation is learned using a least squares method, the prediction value obtained as described above is substituted into Equation 5 and the squared sum of all samples of the error term of Equation 5 is calculated by Equation 7.

$$\begin{matrix}Equation 7 & \\ E = {\sum }_{i = 1}^{N} {( {t}_{i} - {y}_{i} )}^{2} = {\sum }_{i = 1}^{N} {ɛ}_{i}^{2} & ( 7 )\end{matrix}$$

The regression coefficient w₀ in which the squared sum E of all samples of the error term of Equation 7 is derived.

In the classification adaptation process of the related art, the regression coefficient used for the regression prediction operation is composed of a vector in which the number of elements is equal to the number of elements of a tap. For example, if the number of feature amounts (parameters) extracted from the input image is two (for example, the high-pass filter operation value and the low-pass filter operation value), the regression prediction operation using the regression coefficient including two coefficients is performed.

In contrast, in the present invention, it is possible to predict the pixel value by the regression prediction operation using the regression coefficient including only one coefficient w₀ so as to lessen processing load. In the present invention, since the target pixel is classified by repeatedly executing the operation of the discrimination prediction equation using the discrimination coefficient as described below, it is possible to simplify the regression prediction operation using the regression coefficient specified based on the classification result.

Returning to FIG. 1, the regression coefficient learning unit 21 obtains the regression coefficient in this way. The regression coefficient obtained by the regression coefficient learning unit 21 is used for operation for predicting the pixel value of the image, the image quality of which is improved, by the regression prediction.

The regression coefficient obtained by the regression coefficient learning unit 21 is stored in the regression coefficient storage unit 22.

The regression prediction unit 23 sets a predetermined pixel among the pixels configuring the student image as the target pixel. The regression prediction unit 23 calculates the above-described parameters (five feature amounts) by the operation of Equation 1, Equation 2 and Equation 4.

The regression prediction unit 23 substitutes the high-pass filter operation value and the low-pass filter operation value and the regression coefficient w₀ into Equation 6 and calculates the prediction value yᵢ.

The labeling unit 24 compares the prediction value yᵢ calculated by the regression prediction unit 23 with a true value tᵢ which is the pixel value of the teacher image. The labeling unit 24 labels, for example, a target pixel, in which the prediction value yᵢ is equal to or greater than the true value tᵢ, as a discrimination class A and labels a target pixel, in which the prediction value yᵢ is less than the true value tᵢ, as a discrimination class B. That is, the labeling unit 24 classifies the pixels of the student image into the discrimination class A and the discrimination class B based on the operation result of the regression prediction unit 23.

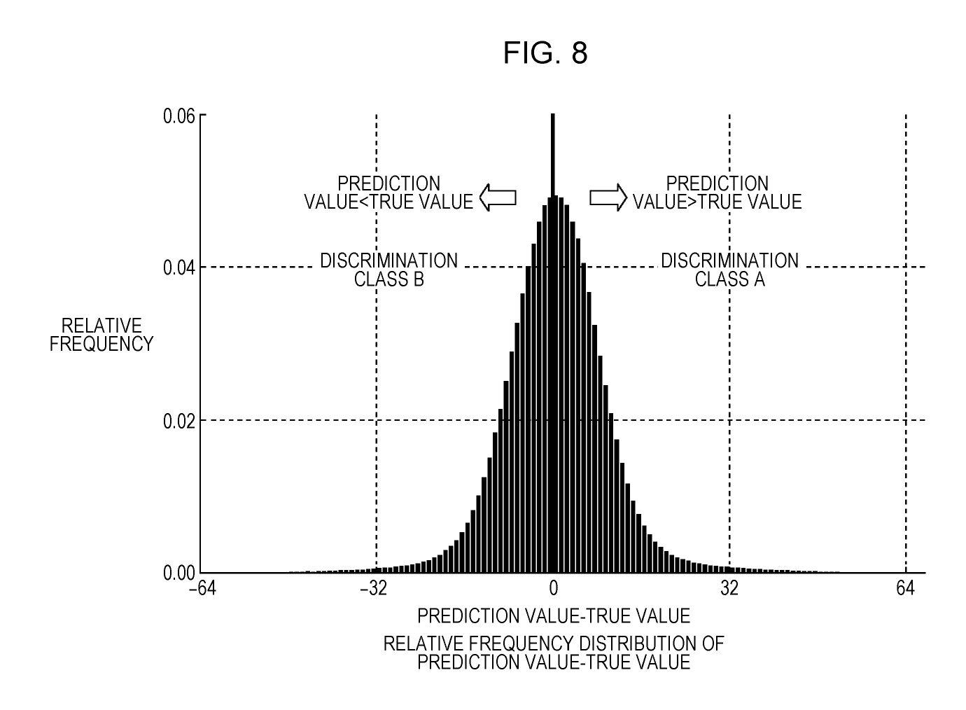

FIG. 8 is a histogram illustrating a process of the labeling unit 24. The horizontal axis of the same figure represents a difference value obtained by subtracting the true value tᵢ from the prediction value yᵢ and the vertical axis represents a relative frequency of a sample (combination of the pixels of the teacher image and the pixels of the student image) in which the difference value is obtained.

As shown in the same figure, by the operation of the regression prediction unit 23, the frequency of a sample in which the difference value obtained by subtracting the true value tᵢ from the prediction value yᵢ becomes 0 is highest. If the difference value is 0, an accurate prediction value (=true value) is calculated by the regression prediction unit 23 such that the image quality improvement process is appropriately performed. That is, since the regression coefficient is learned by the regression coefficient learning unit 21, a possibility that the accurate prediction value is calculated by Equation 6 is high.

However, if the difference value is not 0, the accurate regression prediction is not performed. Then, it is necessary for more appropriately learn the regression coefficient.

In the present invention, for example, it is assumed that if the regression coefficient is learned with respect to only the target pixel, in which the prediction value yᵢ is equal to or greater than the true value tᵢ, it is possible to more appropriately learn the regression coefficient with respect to such a target pixel, and, if the regression coefficient is learned with respect to only the target pixel, in which the prediction value yᵢ is less than the true value tᵢ, it is possible to more appropriately learn the regression coefficient with respect to such a target pixel. To this end, the labeling unit 24 classifies the pixels of the student image into the discrimination class A and the discrimination class B based on the operation result of the regression prediction unit 23.

Thereafter, by the process of the discrimination coefficient learning unit 25, based on the pixel values of the student image, the coefficient used for the prediction operation for classifying the pixels into the discrimination class A and the discrimination class B. That is, in the present invention, even when the true value is unclear, the pixels may be classified into the discrimination class A and the discrimination class B based on the pixel values of the input image.

Although the case where the labeling unit 24 labels the pixel values of the student image is described herein, as the unit of the labeling, accurately, labeling is performed one by one for each tap (the above-described 5 feature amounts) obtained from the student image corresponding to the true value tᵢ which is the pixel value of the teacher image.

The high-pass filter operation value, the low-pass filter operation value, the maximum value of the peripheral pixel value, the minimum value of the peripheral pixel value and the maximum value of the difference absolute value of the peripheral pixel value is called a set of “taps”. That is, the tap may be a five-dimensional feature amount vector. Using the pixels of the student image as the target pixels, the set of taps is extracted in correspondence with the respective target pixels.

In the present invention, the tap used for the operation of the discrimination prediction value and the tap used for the operation of the regression prediction value are different in the number of elements. That is, as expressed by Equation 6, while the number of elements of the tap used for the operation of the regression prediction value is two (the high-pass filter operation value and the low-pass filter operation value), the number of elements of the tap used for the operation of the discrimination prediction value is 5. Hereinafter, the tap used for the operation of the regression prediction value is referred to as a regression tap and the tap used for the operation of the discrimination prediction value is referred to as a discrimination tap.

Although the example of discriminating and labeling the target pixel, in which the prediction value yᵢ is equal to or greater than the true value tᵢ and the target pixel, in which the prediction value yᵢ is less than the true value tᵢ is described herein, labeling may be performed using another method. For example, the target pixel in which the absolute value of the difference between the prediction value yᵢ and the true value tᵢ becomes a value less than a predetermined threshold value may be labeled as the discrimination class A and the target pixel, in which the absolute value of the difference between the prediction value yᵢ and the true value tᵢ becomes a value equal to or greater than the predetermined threshold value may be labeled as the discrimination class B. In addition, the target pixels may be labeled as the discrimination class A and the discrimination class B using the other method. Hereinafter, the example of the case of discriminating and labeling the target pixel, in which the prediction value yᵢ is equal to or greater than the true value tᵢ and the target pixel, in which the prediction value yᵢ is less than the true value tᵢ will be described.

Returning to FIG. 1, the discrimination coefficient learning unit 25 sets a predetermined pixel among the pixels configuring the student image as the target pixel. The discrimination coefficient learning unit 25 learns the coefficient used for the operation of the prediction value for determining the discrimination class A and the discrimination class B, from the pixel values of the target pixel of the student image and the periphery thereof.

In the learning of the discrimination coefficient, based on the feature amount obtained from the pixel values of the target pixel of the student image and the periphery thereof, the prediction value yᵢ for determining the discrimination class A and the discrimination class B is obtained by Equation 8.

Equation 8

yᵢ=z₀+z^{T}xᵢ (8)

Here, xᵢ=(xᵢ^{t1}, xᵢ^{t2}, xᵢ^{(max)}, xᵢ^{(min)}, |xᵢ|^{(max)})^{T}^{^{T}}

In addition, z^{T} denotes a transposed matrix of z expressed by a determinant. z₀ denotes a bias parameter and is a constant term. In Equation 8, the bias parameter z₀ which is the constant term may not be included.

In Equation 8, xᵢ used as the parameter, that is, the vector including the above-described 5 feature amount, is referred to as a tap (discrimination tap) as described above.

The discrimination coefficient learning unit 25 learns and stores the coefficient z and the bias parameter z₀ of Equation 8 in the discrimination coefficient storage unit 26.

The coefficient of the discrimination prediction equation may be, for example, derived by discrimination analysis or may be learned using a least squares method.

The coefficient z of the discrimination prediction equation obtained as described above becomes a vector in which the number (in this case, 5) of elements is equal to the number of elements of the above-described tap. The coefficient z obtained by the discrimination coefficient learning unit 25 is used for the operation for predicting to which of the discrimination class A or the discrimination class B a predetermined target pixel belongs and is referred to as a discrimination coefficient z. In addition, the bias parameter z₀ is a broad discrimination coefficient and, if necessary, is stored in association with the discrimination coefficient z.

In this way, the prediction value is calculated by the discrimination prediction unit 27 using the learned coefficient z so as to determine to which of the discrimination class A or the discrimination class B the target pixel of the student image belongs. The discrimination prediction unit 27 substitutes the discrimination tap and the discrimination coefficient z (also including the bias parameter z₀ if necessary) into Equation 8 and calculates the prediction value yᵢ.

As the result of the operation by the discrimination prediction unit 27, it may be estimated that the target pixel of the discrimination tap in which the prediction value yᵢ is equal to or greater than 0 is a pixel belonging to the discrimination class A and the target pixel of discrimination tap in which the prediction value yᵢ is less than 0 is a pixel belonging to the discrimination class B.

It is not restricted that the prediction based on the operation result of the discrimination prediction unit 27 is necessarily true. That is, the prediction value yᵢ calculated for substituting the discrimination tap and the discrimination coefficient z into Equation 8 is the prediction result from the pixel value of the student image without being related to the pixel value (true value) of the teacher image, the pixel belonging to the discrimination class A may be fundamentally estimated as the pixel belonging to the discrimination class B or the pixel belonging to the discrimination class B may be estimated as the pixel belonging to the discrimination class A.

Accordingly, in the present invention, the discrimination coefficient is repeatedly learned such that it is possible to perform prediction with higher accuracy.

That is, the classification unit 28 classifies the pixels configuring the student image into the pixel belonging to the discrimination class A and the pixel belonging to the discrimination class B based on the prediction result of the discrimination prediction unit 27.

The regression coefficient learning unit 21 learns and stores the regression coefficient in the regression coefficient storage unit 22 similar to the above-described case, with respect to only the pixel belonging to the discrimination class A by the classification unit 28. The regression prediction unit 23 calculates the prediction value by the regression prediction similar to the above-described case, with respect to only the pixel belonging to the discrimination class A by the classification unit 28.

The prediction value and the true value obtained in this way are compared and the labeling unit 24 further labels the pixel belonging to the discrimination class A by the classification unit 28 as the discrimination class A and the discrimination class B.

The regression coefficient learning unit 21 learns the regression coefficient similar to the above-described case, with respect to only the pixel belonging to the discrimination class B by the classification unit 28. The regression prediction unit 23 calculates the prediction value by the regression prediction similar to the above-described case, with respect to only the pixel belonging to the discrimination class B by the classification unit 28.

The prediction value and the true value obtained in this way are compared and the labeling unit 24 further labels the pixel belong to the discrimination class B by the classification unit 28 as the discrimination class A and the discrimination class B.

That is, the pixels of the student image are classified into four sets. A first set is a set of pixels belonging to the discrimination class A by the classification unit 28 and pixels labeled as the discrimination class A by the labeling unit 24. A second set is a set of pixels belonging to the discrimination class A by the classification unit 28 and pixels labeled as the discrimination class B by the labeling unit 24. A third set is a set of pixels belonging to the discrimination class B by the classification unit 28 and pixels labeled as the discrimination class A by the labeling unit 24. A fourth set is a set of pixels belonging to the discrimination class B by the classification unit 28 and pixels labeled as the discrimination class B by the labeling unit 24.

Thereafter, the discrimination coefficient learning unit 25 learns the discrimination coefficient again similar to the above-described case based on the first set and the second set among the above-described four sets. The discrimination coefficient learning unit 25 learns the discrimination coefficient again similar to the above-described case based on the third and the fourth set of the above-described four sets.

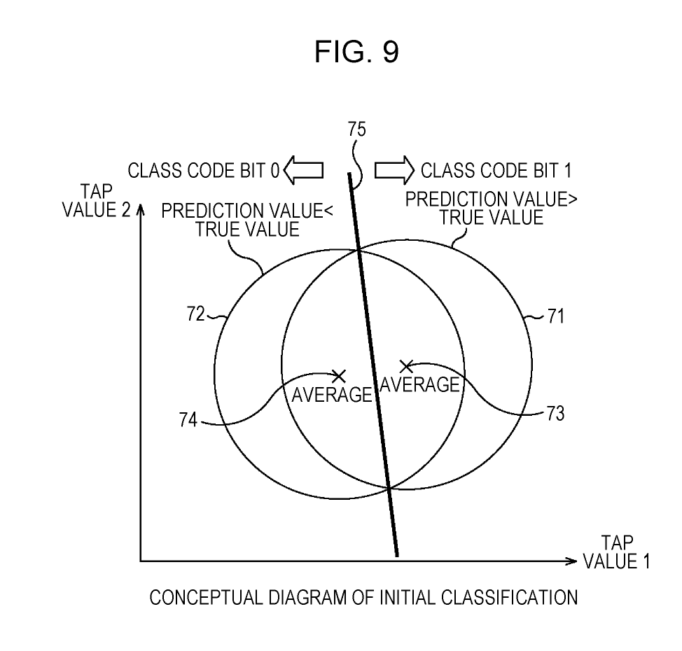

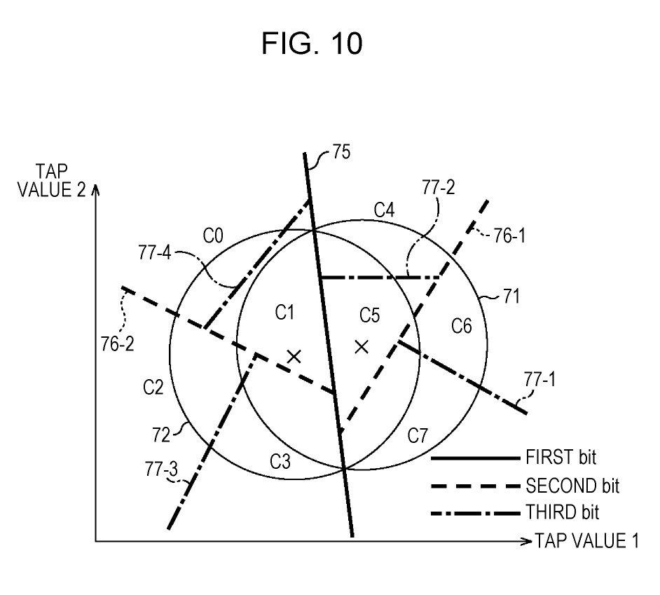

FIGS. 9 and 10 are diagrams illustrating the learning of the discrimination coefficient performed repeatedly.

FIG. 9 is a diagram showing a space representing each tap (discrimination tap) of the student image using a tap value 1 of a horizontal axis and a tap value 2 of a vertical axis as a tap value obtained from the student image. That is, in the same figure, in order to simplify description, the number of elements of tap is virtually set to 2 and all taps which may be present in the student image are shown on a two-dimensional space. Accordingly, in the same figure, it is assumed that the tap is a vector including two elements.

A circle 71 shown in the same figure represents a set of taps corresponding to the pixels first labeled as the discrimination class A by the labeling unit 24 and a circle 72 represents a set of taps corresponding to the pixels first labeled as the discrimination class B by the labeling unit 24. A symbol 73 shown in the circle 71 represents the position of an average value of the values of the elements of the tap included in the circle 71 and a symbol 74 shown in the circle 71 represents the position of an average value of the values of the elements of the tap included in the circle 72.

As shown in the same figure, since the circle 71 and the circle 72 overlap each other, only based on the values of the elements of the tap obtained from the student image, the tap corresponding to the pixel labeled as the discrimination class A and the tap corresponding to the pixel labeled as the discrimination class B may not be accurately discriminated.

However, based on a symbol 73 and a symbol 74, it is possible to roughly specify a boundary line 75 for discriminating the two classes. The process of specifying the boundary line 75 corresponds to the discrimination prediction process of the discrimination prediction unit 27 using the discrimination coefficient obtained by first learning performed by the discrimination coefficient learning unit 25. In addition, the tap located on the boundary line 75 is a tap in which the prediction value yᵢ calculated by Equation 8 is 0.

In order to identify the set of taps located on the right side of the boundary line 75, the classification unit 28 assigns a class code bit 1 to the pixels corresponding to such taps. In order to identify the set of taps located on the left side of the boundary line 75, the classification unit 28 of FIG. 1 assigns a class code bit 0 to the pixels corresponding to such taps.

The discrimination coefficient obtained by the first learning may be stored in the discrimination coefficient storage unit 26 of FIG. 1 in association with a code or the like representing the discrimination coefficient used for first discrimination prediction. Based on the first discrimination prediction result, the regression coefficient is learned again so as to perform regression prediction only based on the pixels to which the class code bit 1 is assigned. Similarly, based on the first discrimination prediction result, the regression coefficient is learned again so as to perform regression prediction only based on the pixels to which the class code bit 0 is assigned.

Based on the pixel group to which the class code bit 1 is assigned and the pixel group to which the class code bit 0 is assigned, the learning of the discrimination coefficient is repeated. As a result, the pixel group to which the class code bit 1 is assigned is further divided to two and the pixel group to which the class code bit 2 is assigned is divided into two. Division at this time is performed by the discrimination prediction of the discrimination prediction unit 27 using the discrimination coefficient obtained by second learning performed by the discrimination coefficient learning unit 25.

The discrimination coefficient obtained by the second learning may be stored in the discrimination coefficient storage unit 26 of FIG. 1 in association with a code or the like representing the discrimination coefficient used for second discrimination prediction. The discrimination coefficient obtained by the second learning is used for the discrimination prediction performed with respect to each of the pixel group to which the class code bit 1 is assigned by the first discrimination prediction and the pixel group to which the class code bit 0 is assigned by the first discrimination prediction and thus is stored in the discrimination coefficient storage unit 26 of FIG. 1 in association with a code or the like representing with respect to which pixel group the discrimination coefficient is used for the discrimination prediction. That is, two discrimination coefficients used for the second discrimination prediction are stored.

Based on the first and second discrimination prediction results, the regression coefficient is learned again so as to perform regression prediction based on only the pixels to which the class code bit 11 is assigned. Similarly, based on the first and second discrimination prediction results, the regression coefficient is learned again so as to perform regression prediction based on only the pixels to which the class code bit 10 is assigned. In addition, based on the first and second discrimination prediction results, the regression coefficient is learned again so as to perform regression prediction based on only the pixels to which the class code bit 01 is assigned and the regression coefficient is learned again so as to perform regression prediction based on only the pixels to which the class code bit 00 is assigned.

By repeating such a process, the space shown in FIG. 9 is divided as shown in FIG. 10.

FIG. 10 is a diagram showing a space representing each tap (discrimination tap) of the student image using a tap value 1 of a horizontal axis and a tap value 2 of a vertical axis, similar to FIG. 9. In the same figure, an example of the case of repeatedly performing the learning of the discrimination coefficient three times by the discrimination coefficient learning unit 25 is shown. That is, a boundary lien 75 is specified by the discrimination prediction using the discrimination coefficient obtained by first learning and a boundary line 76-1 and a boundary line 76-2 are specified by the discrimination prediction using the discrimination coefficient obtained by second learning. Boundary lines 77-1 to 77-4 are specified by the discrimination prediction using the discrimination coefficient obtained by third learning.

The classification unit 28 of FIG. 1 assigns a class code bit of a first bit in order to identify a set of taps divided by the boundary line 75, assigns a class code bit of a second bit in order to identify a set of taps divided by the boundary lines 76-1 and the boundary line 76-2, and assigns a class code bit of a third bit in order to identify a set of taps divided by the boundary lines 77-1 to 77-4.

Accordingly, as shown in FIG. 10, the taps obtained from the student image are divided (classified) into eight classes of class numbers C0 to C7 specified based on a 3-bit class code.

If classification is performed as shown in FIG. 10, one discrimination coefficient used for the first discrimination prediction, two discrimination coefficients used for the second discrimination prediction, and four discrimination coefficients used for the third discrimination prediction are stored in the discrimination coefficient storage unit 26 of FIG. 1.

If classification is performed as shown in FIG. 10, eight regression coefficients respectively corresponding to class numbers C0 to C7 are stored in the regression coefficient storage unit 22 of FIG. 1. The eight regression coefficients respectively corresponding to the class numbers C0 to C7 are stored by learning the regression coefficients again for each class number using the taps (regression taps) of the target pixel of the student image classified into the class numbers C0 to C7 and the pixel values of the teacher image corresponding to the target pixel as the sample, as the result of the third discrimination prediction.

In this way, if the discrimination coefficients are learned using the student image and the teacher image in advance and the discrimination prediction is repeated with respect to the input image, it is possible to classify the pixels of the input image into eight classes of the class number C0 to C7. If the regression prediction is performed using the taps corresponding to the pixels classified into the eight classes and the regression coefficients corresponding to the classes, it is possible to appropriately perform an image quality improvement process.

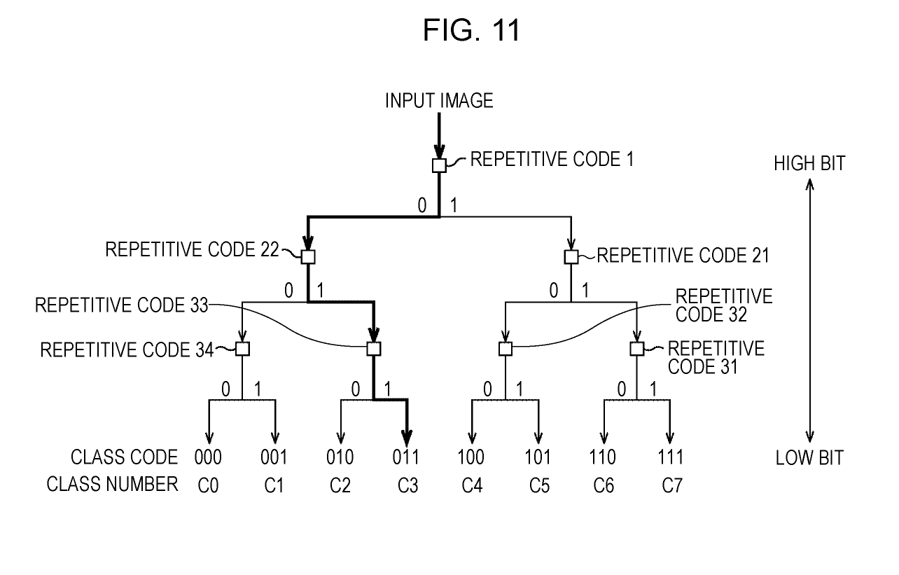

FIG. 11 is a diagram illustrating an example of the case of classifying the input image as shown in FIG. 10 using a two-branch structure. The pixels of the input image are classified into pixels to which the class code bit 1 or 0 of the first bit is assigned by the first discrimination prediction. At this time, the discrimination coefficient used for discrimination prediction is a discrimination coefficient corresponding to a repetitive code 1 and is stored in the discrimination coefficient storage unit 26 of FIG. 1.

The pixels to which the class code bit 1 of the first bit is assigned are further classified into pixels to which the class code bit 1 or 0 of the second bit is assigned. At this time, the discrimination coefficient used for the discrimination prediction is a discrimination coefficient corresponding to a repetitive code 21 and is stored in the discrimination coefficient storage unit 26 of FIG. 1. Similarly, the pixels to which the class code bit 0 of the first bit is assigned are further classified into pixels to which the class code bit 1 or 0 of the second bit is assigned. At this time, the discrimination coefficient used for the discrimination prediction is a discrimination coefficient corresponding to a repetitive code 22 and is stored in the discrimination coefficient storage unit 26 of FIG. 1.

The pixels to which the class code bit 11 of the first bit and the second bit is assigned are further classified into pixels to which the class code bit 1 or 0 of the third bit is assigned. At this time, the discrimination coefficient used for the discrimination prediction is a discrimination coefficient corresponding to a repetitive code 31 and is stored in the discrimination coefficient storage unit 26 of FIG. 1. The pixels to which the class code bit 10 of the first bit and the second bit is assigned are further classified into pixels to which the class code bit 1 or 0 of the third bit is assigned. At this time, the discrimination coefficient used for the discrimination prediction is a discrimination coefficient corresponding to a repetitive code 32 and is stored in the discrimination coefficient storage unit 26 of FIG. 1.

Similarly, the pixels to which the class code bit 01 or 00 of the first bit and the second bit is assigned are further classified into pixels to which the class code bit 1 or 0 of the third bit is assigned. The discrimination coefficient used for the discrimination prediction is a discrimination coefficient corresponding to a repetitive code 33 or a repetitive code 34 and is stored in the discrimination coefficient storage unit 26 of FIG. 1.

In this way, by repeatedly performing the discrimination three times, the class code including 3 bits is set to the pixels of the input image so as to specify the class numbers. The regression coefficients corresponding to the specified class numbers are also specified.

In this example, values for connecting the class code bits from a high-order bit to a low-order bit in order of the number of repetitions corresponds to the class number. Accordingly, the class number Ck corresponding to the final class code is, for example, specified as Equation 9.

Equation 9

k={011}₂=3 (9)

As shown in FIG. 11, the relationship between the number p of repetitions and the number N_{c} of final classes is expressed by Equation 10.

Equation 10

N_{c}=2^{p} (10)

In addition, the number N_{c} of final classes becomes equal to the total number Nₘ of regression coefficients used finally.

The total N_{d} number of discrimination coefficients is expressed by Equation 11.

Equation 11

N_{d}=2^{p}−1 (11)

In the discrimination prediction of the image quality improvement process using the below-described image processing apparatus, by adaptively reducing the number of repetitions, it is possible to improve processing robustness or increase a processing speed. In this case, since the regression coefficients used for each branch of FIG. 11 are also necessary, the total number Nₘ of regression coefficients is expressed by Equation 12.

Equation 12

Nₘ=2^{p+1}−1 (12)

Although the example of repeatedly learning the discrimination coefficients three times is mainly described, the number of repetitions may be one. That is, after the first learning of the discrimination coefficient is finished, the operation of the discrimination coefficient by the discrimination coefficient learning unit 25 and the discrimination prediction by the discrimination prediction unit 27 may not be repeatedly executed.

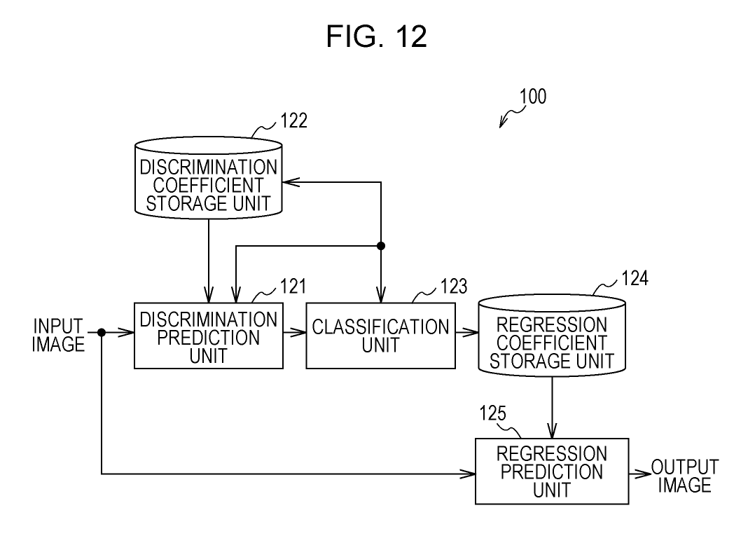

FIG. 12 is a block diagram showing a configuration example of an image processing apparatus according to an embodiment of the present invention. The image processing apparatus 100 of the same figure corresponds to the learning apparatus 10 of FIG. 1. That is, the image processing apparatus 100 discriminates the respective classes of the pixels of the input image using the discrimination coefficients learned by the learning apparatus 10. The image processing apparatus 100 performs regression prediction operation of the tap obtained from the input image using the regression coefficients learned by the learning apparatus 10 as the regression coefficients corresponding to the discriminated classes and performs an image process for improving the quality of the input image.

That is, the discrimination coefficients stored in the discrimination coefficient storage unit 26 of the learning apparatus 10 are stored in a discrimination coefficient storage unit 122 of the image processing apparatus 100 in advance. The regression coefficients stored in the regression coefficient storage unit 22 of the learning apparatus 10 are stored in a regression coefficient storage unit 124 of the image processing apparatus 100 in advance.

A discrimination prediction unit 121 of the same figure sets a target pixel with respect to the input image, acquires a discrimination tap (5-dimensional feature amount vector) corresponding to the target pixel, and performs operation by referring to Equation 8. At this time, the discrimination prediction unit 121 specifies a repetitive code based on the number of repetitions and a pixel group to be subjected to discrimination prediction and reads a discrimination coefficient corresponding to the repetitive code from the discrimination coefficient storage unit 122.

The classification unit 123 assigns the class code bit to the target pixel based on the prediction result of the discrimination prediction unit 121 so as to classify the pixels of the input image into two sets. At this time, as described above, for example, the prediction value yᵢ calculated by Equation 8 is compared with 0 so as to assign the class code bit to the target pixel.

After the process of the classification 123, the discrimination prediction unit 121 repeatedly performs discrimination prediction such that new classification is performed by the classification unit 123. The discrimination prediction is repeatedly performed only by predetermined number of repetitions. For example, if the discrimination prediction is repeatedly performed three times, for example, as described above with reference to FIG. 10 or 11, the input image is classified into pixel groups corresponding to the class numbers of the 3-bit class code.

In addition, the number of repetitions of the discrimination prediction of the image processing apparatus 100 is set to be equal to the number of repetitions of the learning of the discrimination coefficient by the learning apparatus 10.

The classification unit 123 supplies the information for specifying the pixels of the input image to the regression coefficient storage unit 124 in association with the class numbers of the pixels.

The regression prediction unit 125 sets a target pixel in the input image, acquires a regression tap (two-dimensional feature amount vector) corresponding to the target pixel, and performs operation predicted with reference to Equation 6. At this time, the regression prediction unit 125 supplies the information for specifying the target pixel to the regression coefficient storage unit 124 and reads the regression coefficient corresponding to the class number of the target pixel from the regression coefficient storage unit 124.

An output image having the prediction value obtained by the operation of the regression prediction unit 125 as the pixel value corresponding to the target pixel is generated. Accordingly, it is possible to obtain an output image obtained by improving the image quality of the input image.

In this way, according to the present invention, by performing the discrimination prediction with respect to the input image, the pixels (actually, the tap corresponding to the target pixel) configuring the input image may be classified into classes suitable for the image quality process.

For example, by the classification adaptation process of the related art, if an image obtained by improving the resolution/sharpness of the input image is predicted, it is necessary to change the process according to an image band or type (natural image/artificial image) and a noise amount in order to cope with various input signals.

However, in this case, it is necessary to consider enormous patterns and it is difficult to cover all cases. Thus, the resolution/sharpness of the image which may be obtained as the result of performing the prediction process may not be improved. On the contrary, the process is extremely strong such that ringing deterioration or noise may be emphasized.

In contrast, in the present invention, it is not necessary to change the process according to an image band or type (natural mage/artificial image) and a noise amount. Thus, there are no problems that the resolution/sharpness of the image which may be obtained as the result of performing the prediction process may not be improved and the process is extremely strong such that ringing deterioration or noise may be emphasized.

In the classification adaptation process of the related art, the regression coefficient used for the regression prediction operation is composed of a vector in which the number of elements is equal to the number of elements of the tap (regression tap). For example, if the number of feature amounts extracted from the input image is two, the regression prediction operation using the regression coefficient including two coefficients is performed.

In contrast, in the present invention, it is possible to predict the pixel value by the regression prediction operation using the regression coefficient including only one coefficient so as to lessen processing load. In the present invention, since the target pixel is classified by repeatedly executing the operation of the discrimination prediction equation using the discrimination coefficient as described below, it is possible to simplify the regression prediction operation using the regression coefficient specified based on the classification result.

In addition, in the present invention, by repeatedly performing the discrimination prediction, it is possible to more appropriately perform classification. Since it is not necessary to generate intermediate data obtained by processing the pixel values of the input image while the repeatedly performed discrimination prediction process is performed, it is possible to increase the processing speed. That is, when the output image is predicted, since the classification and the regression prediction may be performed by performing the operation of only (p+1) times with respect to any pixel, it is possible to perform a high-speed process. In addition, when the classification and the regression prediction are performed since only the operation of the input is completed without using the intermediate data of the operation of the tap, it is possible to use a pipeline in mounting.

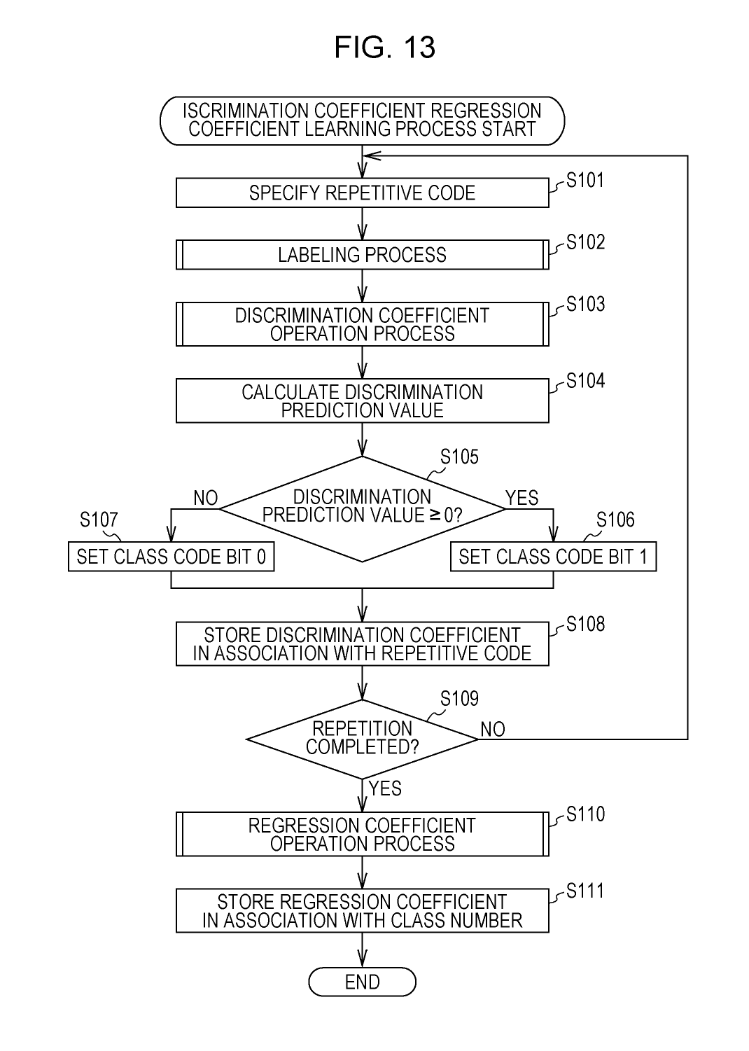

Next, the details of the discrimination coefficient regression coefficient learning process will be described with reference to the flowchart of FIG. 13. This process is executed by the learning apparatus 10 of FIG. 1.

In step S101, the discrimination coefficient learning unit 25 specifies the repetitive code. Since this process is the first learning process, the repetitive code is specified to 1.

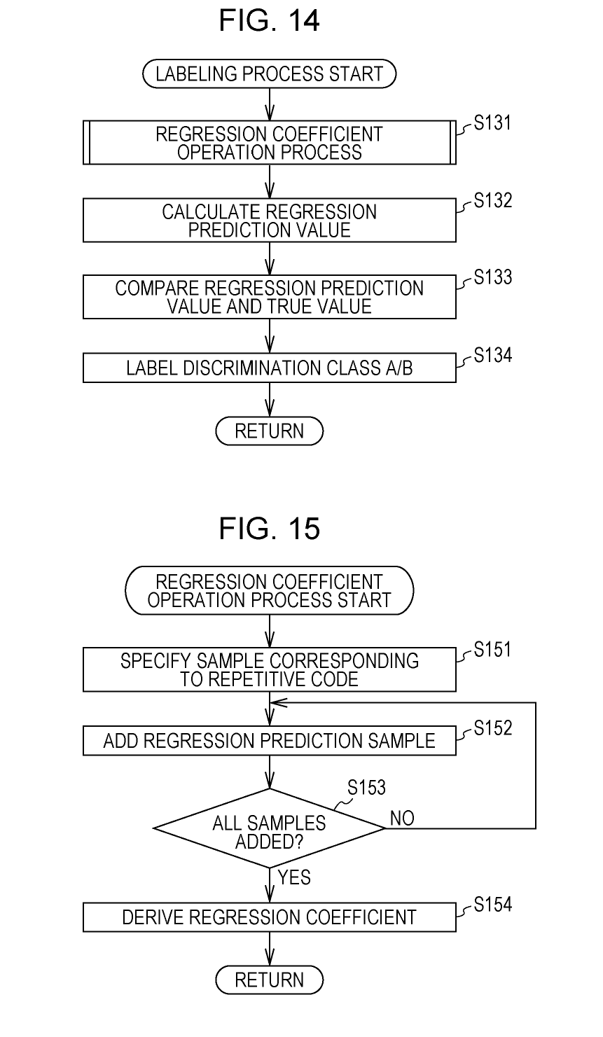

In step S102, the regression coefficient learning unit 21 to the labeling unit 24 executes the labeling process described below with reference to FIG. 14. Now, the detailed example of the labeling process of step S102 of FIG. 13 will be described with reference to the flowchart of FIG. 14.

In step S131, the regression coefficient learning unit 21 executes the regression coefficient learning process described below with reference to FIG. 15. Accordingly, the regression coefficient used for the operation for predicting the pixel value of the teacher image based on the pixel value of the student image is obtained.

In step S132, the regression prediction unit 23 calculates the regression prediction value using the regression coefficient obtained by the process of step S131. At this time, for example, the operation of Equation 6 is performed and the prediction value yᵢ is obtained.

In step S133, the labeling unit 24 compares the prediction value yᵢ obtained by the process of step S132 with the true value tᵢ which is the pixel value of the teacher image.

In step S134, the labeling unit 24 labels the target pixel (actually, the tap corresponding to the target pixel) to the discrimination class A or the discrimination class B based on the comparison result of step S133. Thus, for example, as described above with reference to FIG. 8, the labeling of the discrimination class A or the discrimination class B is performed.

In addition, the processes of step S132 to step S134 are performed with respect to each pixel to be processed in correspondence with the repetitive code.

In this way, the labeling process is executed.

Next, the detailed example of the regression coefficient operation process of step S131 of FIG. 14 will be described with reference to the flowchart of FIG. 15.

In step S151, the regression coefficient learning unit 21 specifies the sample corresponding to the repetitive code specified by the process of step S101. Here, the sample refers to a combination of the tap corresponding to the target pixel of the student image and the pixel of the teacher image corresponding to the target pixel. In addition, since the regression prediction operation is expressed by Equation 6, the tap (regression tap) described herein becomes a vector including two elements of the high-pass filter operation value and the low-pass filter operation value.

For example, if the repetitive code is 1, since the first learning process is performed, the sample is specified using each of all the pixels of the student image as the target pixel. For example, if the repetitive code is 21, if a part of the second learning process is performed, the sample is specified using each of the pixels, to which the class code bit 1 is assigned by the first learning process, among the pixels of the student image as the target pixel. For example, if the repetitive code is 34, if a part of the third learning process is performed, the sample is specified using each of the pixels, to which the class code bit 0 is assigned by the first learning process and the class code bit 0 is assigned by the second learning process, among the pixels of the student image as the target pixel.

In step S152, the regression coefficient learning unit 21 adds the sample specified by the process of step S151. At this time, for example, the tap of the sample and the pixel value of the teacher image are added to Equation 5.

In step S153, the regression coefficient learning unit 21 determines whether or not all samples are added and repeatedly executes the process of step S152 until it is determined that all sample are added.

In step S154, the regression coefficient learning unit 21 performs the operation of Equation 7 and derives the regression coefficient w₀ using the least squares method.

In this way, the regression coefficient operation process is executed.

If the labeling process of step S102 of FIG. 13 is completed by the above process, the process proceeds to the discrimination coefficient operation process of step S103 of FIG. 13.

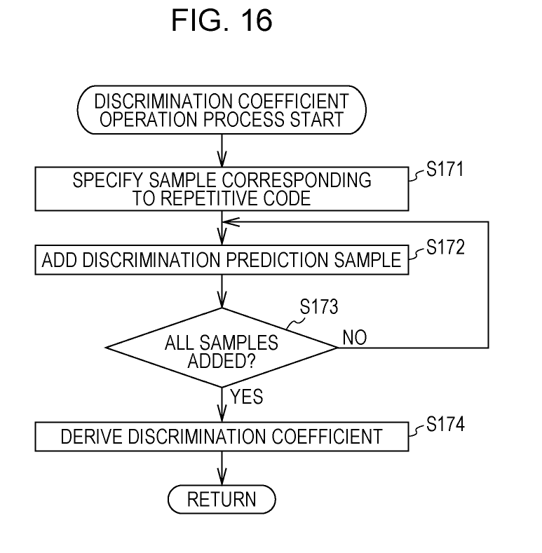

In step S103, the discrimination coefficient learning unit 25 executes the discrimination coefficient operation process described below with reference to FIG. 16. Now, the detailed example of the discrimination coefficient operation process of step S103 of FIG. 13 will be described with reference to the flowchart of FIG. 16.

In step S171, the discrimination coefficient learning unit 25 specifies the sample corresponding to the repetitive code specified by the process of step S101. Here, the sample refers to a combination of the tap corresponding to the target pixel of the student image and the labeling result of the discrimination class A or the discrimination class B for the target pixel. In addition, the tap (discrimination tap) described herein becomes a vector having five feature amounts including the high-pass filter operation value, the low-pass filter operation value, the maximum value of the peripheral pixel value, the minimum value of the peripheral pixel value and the maximum value of the difference absolute value of the peripheral pixel value as the elements.

For example, if the repetitive code is 1, since the first learning process is performed, the sample is specified using each of all the pixels of the student image as the target pixel. For example, if the repetitive code is 21, if a part of the second learning process is performed, the sample is specified using each of the pixels, to which the class code bit 1 is assigned by the first learning process, among the pixels of the student image as the target pixel. For example, if the repetitive code is 34, if a part of the third learning process is performed, the sample is specified using each of the pixels, to which the class code bit 0 is assigned by the first learning process and the class code bit 0 is assigned by the second learning process, among the pixels of the student image as the target pixel.

In step S172, the discrimination coefficient learning unit 25 adds the sample specified by the process of step S171.

In step S173, the discrimination coefficient learning unit 25 determines whether or not all samples are added and repeatedly executes the process of step S172 until it is determined that all sample are added.

In step S174, the discrimination coefficient learning unit 25 derives the discrimination coefficient, for example, by the discrimination analysis (the least squares method may be used).

In this way, the discrimination coefficient operation process is executed.

Returning to FIG. 13, in step S104, the discrimination prediction unit 27 calculates the discrimination prediction value using the tap obtained from the student image and the coefficient obtained by the process of step S103. At this time, for example, the operation of Equation 8 is performed and the prediction value yᵢ (discrimination prediction unit) is obtained.

In step S105, the classification unit 28 determines whether or not the discrimination prediction value obtained by the process of step S104 is equal to or greater than 0.

If it is determined that the discrimination prediction value is equal to or greater than 0 in step S105, the process proceeds to step S106 of setting the class code bit 1 to the target pixel (actually, the tap). In contrast, if it is determined that the discrimination prediction value is less than 0 in step S105, the process proceeds to step S107 and the class code bit 0 is set to the target pixel (actually, the tap).

In addition, the processes of step S104 to step S107 are performed with respect to each of the pixels to be processed in correspondence with the repetitive code.

After the process of step S106 or step S107, the process proceeds to step S108 and the discrimination coefficient storage unit 26 stores the discrimination coefficient obtained in the process of step S103 in association with the repetitive code specified in step S101.

In step S109, the learning apparatus 10 determines whether or not repetition is completed. For example, if it is previously set that learning is repeatedly performed three times, it is determined that the repetition is not completed and the process returns to step S101.

In step S101, the repetitive code is specified again. Since this process is the first process of the second learning, the repetitive process is specified to 21.

Similarly, the processes of step S102 to S108 are executed. At this time, as described above, in the process of step S102 and the process of step S103, the sample is specified using each of the pixels to which the class code bit 1 is assigned by the first learning process among the pixels of the student image as the target pixel.

It is determined whether or not repetition is completed in step S109.

The processes of steps S101 to S108 are repeatedly executed until it is determined that the repetition is completed in step S109. If it is previous set that the learning is repeatedly performed three times, after the repetitive code is specified to 34 in step S101, the processes of steps S102 to S108 are executed and it is determined that the repetition is completed in step S109.

By repeatedly executing the processes of steps S101 to S109, 7 discrimination coefficients are stored in the discrimination coefficient storage unit 26 in association with the repetitive codes.

If it is determined that the repetition is completed in step S109, the process proceeds to step S110.

In step S110, the regression coefficient learning unit 21 executes the regression coefficient operation process. This process is equal to the case described above with reference to the flowchart of FIG. 15 and thus the detailed description will be omitted. However, in this case, in step S151, the sample corresponding to the repetitive code is not specified, but the sample corresponding to each class number is specified.

That is, by repeatedly executing the processes of steps S101 to S109, as described above with reference to FIG. 8, the pixels of the student image classified into several classes of the class numbers C0 to C7. Accordingly, the sample is specified using the pixel of the class number C0 of the student image as the target pixel so as to derive the first regression coefficient. In addition, the sample is specified using the pixel of the class number C1 of the student image as the target pixel so as to derive the second regression coefficient, the sample is specified using the pixel of the class number C2 of the student image as the target pixel so as to derive the third regression coefficient, . . . , and the sample is specified using the pixel of the class number C7 of the student image as the target pixel so as to derive the eighth regression coefficient.

That is, in the regression coefficient operation process of step S110, the eight regression coefficients corresponding to the class numbers C0 to C7 are obtained.

In step S111, the regression coefficient storage unit 22 stores the eight regression coefficients obtained by the process of step S110 in association with the class numbers.

In this way, the discrimination regression coefficient learning process is executed.

In addition, although the example of repeatedly performing the discrimination coefficient learning three times is mainly described herein, the number of repetitions may be one. That is, after the first discrimination coefficient learning is completed, the discrimination coefficient operation by the discrimination coefficient learning unit 25 and the discrimination prediction by the discrimination prediction unit 27 may not be repeatedly executed.

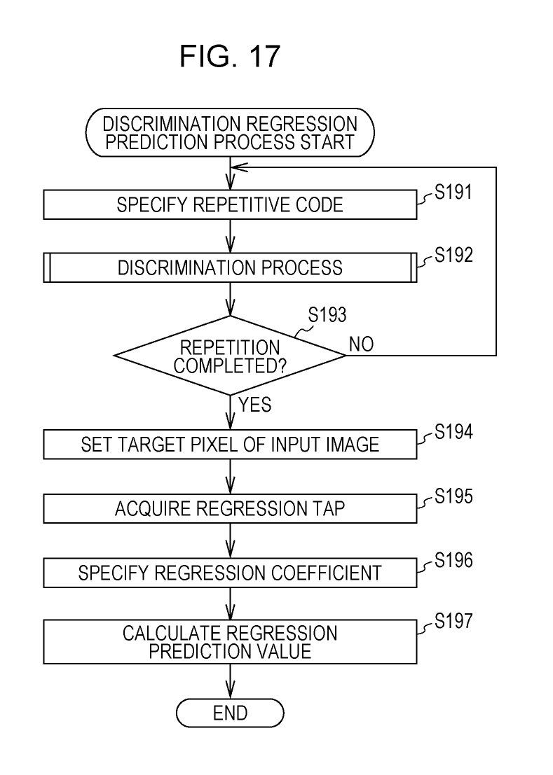

Next, the example of the discrimination regression prediction process will be described with reference to the flowchart of FIG. 17. This process is executed by the image processing apparatus 100 of FIG. 12. Prior to the execution of the process, the seven discrimination coefficients stored in the discrimination coefficient storage unit 26 and the eight regression coefficients stored in the regression coefficient storage unit 22 are respectively stored in the discrimination coefficient storage unit 122 and the regression coefficient storage unit 124 of the image processing apparatus 100 by the discrimination regression coefficient learning process of FIG. 13.

In step S191, the discrimination prediction unit 121 specifies the repetitive code. Since this process is the first learning process, the repetitive code is specified to 1.

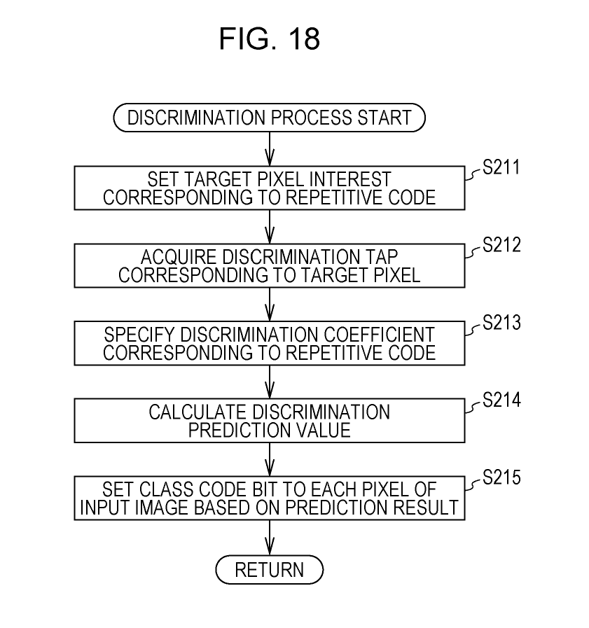

In step S192, the discrimination prediction unit 121 executes the discrimination process described below with reference to FIG. 18. Now, the detailed example of the discrimination process of step S192 of FIG. 17 will be described with reference to the flowchart of FIG. 18.

In step S211, the discrimination prediction unit 121 sets the target pixel corresponding to the repetitive code. For example, if the repetitive code is 1, since the first discrimination process is performed, each of all the pixels of the input image is set as the target pixel. For example, if the repetitive code is 21, if a part of the second discrimination process is performed, among the pixels of the input image, each of the pixels to which the class code bit 1 is assigned by the first discrimination process is set as the target pixel. For example, if the repetitive code is 34, if a part of the third discrimination process is performed, among the pixels of the input image, each of the pixels to which the class code bit 0 is assigned by the first discrimination process and the class code bit 0 is assigned by the second discrimination process is set as the target pixel.

In step S212, the discrimination prediction unit 121 acquires the discrimination tap corresponding to the target pixel set in step S211.

In step S213, the discrimination prediction unit 121 specifies and reads the discrimination coefficient corresponding to the repetitive code specified by the process of step S211 from the discrimination coefficient storage unit 122.

In step S214, the discrimination prediction unit 121 calculates the discrimination prediction value. At this time, for example, Equation 8 is calculated.

In step S215, the classification unit 123 sets (assigns) the class code bit to the target pixel based on the discrimination prediction value calculated by the process of step S214. At this time, as described above, for example, the prediction value yᵢ calculated by Equation 8 is compared with 0 so as to assign the class code bit to the target pixel.

In addition, the processes of step S211 to step S215 are performed with respect to each of the pixels to be processed in correspondence with the repetitive code.

In this way, the discrimination process is executed.

Returning to FIG. 17, after the process of step S192, in step S193, the discrimination prediction unit 121 determines whether or not the repetition is completed. For example, if it is previously set that the learning is repeatedly three times, the repetition is not completed and the process returns to step S191.

Thereafter, in step S191, the repetitive code 21 is specified and, similarly, the process of step S192 is executed. At this time, as described above, in the process of step S192, among the pixels of the input image, each of pixels to which the class code bit 1 is assigned by the first discrimination process is set as the target pixel.

In step S193, it is determined whether or not the repetition is completed.

The processes to steps S191 to S193 are repeatedly executed until it is determined that the repetition is completed in step S193. If it is previously set that the learning is repeatedly three times, after the repetitive code is specified to 34 in step S191, the process of step S192 is executed and it is determined that the repetition is completed in step S193.

In step S193, if it is determined that the repetition is completed, the process proceeds to step S194. In addition, by the above processes, as described above with reference to FIG. 10 or 11, the input image is classified into the pixel groups corresponding to the class numbers of the 3-bit class code. As described above, the classification unit 123 supplies the information for specifying the pixels of the input image to the regression coefficient storage unit 124 in association with the class numbers of the pixels.

In step S194, the regression prediction unit 125 sets the target pixel in the input image.

In step S195, the regression prediction unit 125 acquires the regression tap corresponding to the target pixel set in step S194.

In step S196, the regression prediction unit 125 supplies the information for specifying the target pixel set in step S194 to the regression coefficient storage unit 124 and specifies reads the regression coefficient corresponding to the class number of the target pixel from the regression coefficient storage unit 124.

In step S197, the regression prediction unit 125 performs the operation of Equation 6 using the regression tap acquired in step S195 and the regression coefficient specified and read in step S196 and calculates the regression prediction value.

In addition, the processes of step S191 to step S197 are performed with respect to each pixel of the input image.

An output image in which the prediction value obtained by the operation of the regression prediction unit 125 is the pixel value corresponding to the target pixel is generated. Accordingly, it is possible to obtain an output image obtained by improving the image quality of the input image.

In this way, the discrimination prediction process is executed. Accordingly, it is possible to perform the process of more efficiently improving the image quality of the image at a higher speed.

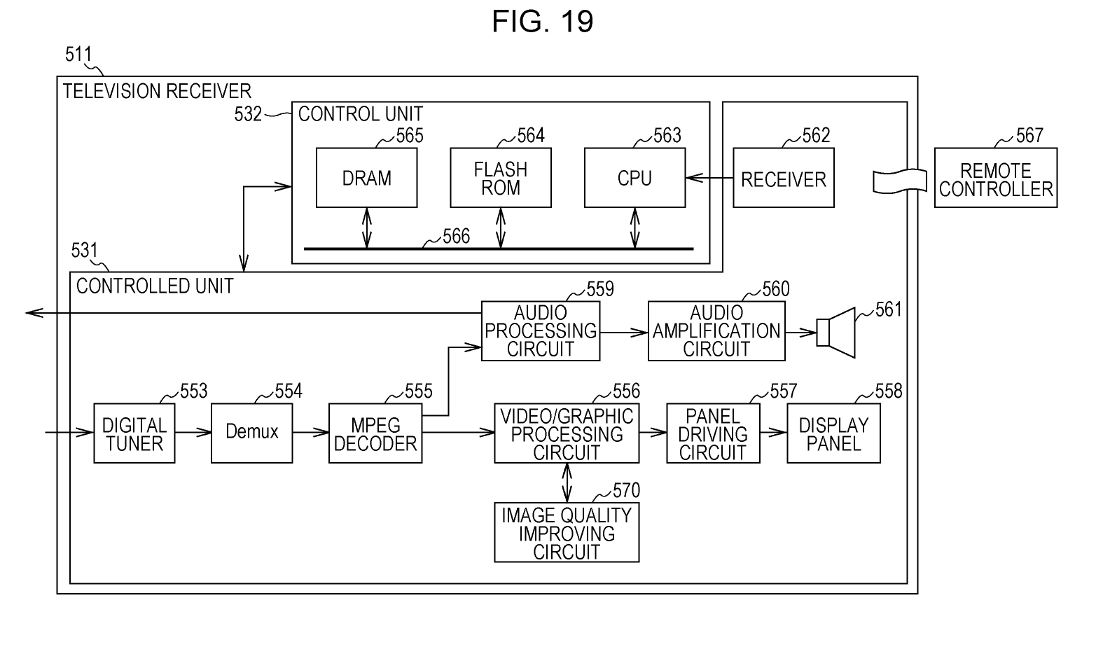

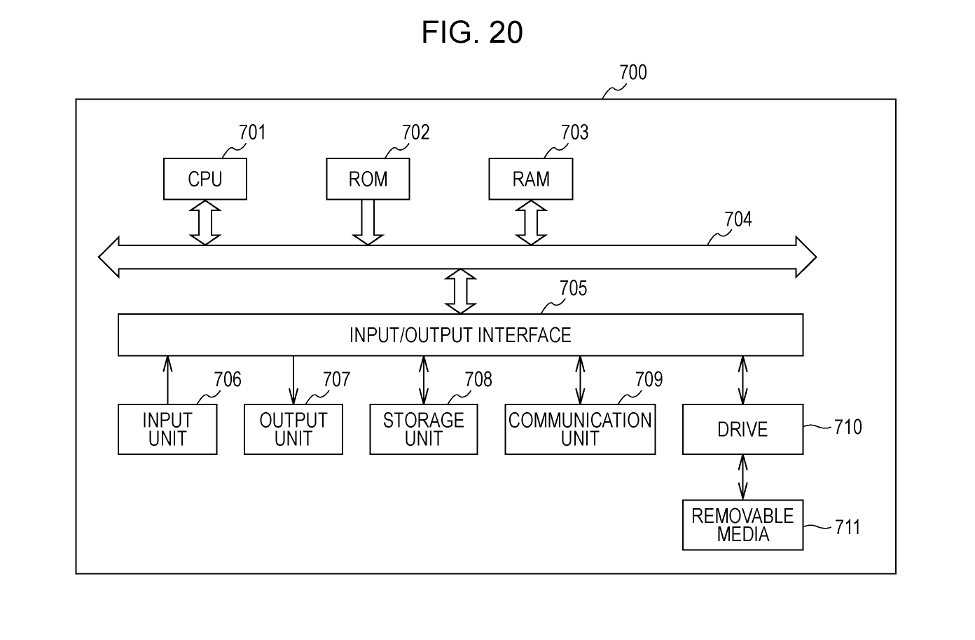

The image processing apparatus described above with reference to FIG. 12 is, for example, a high-quality circuit and may be mounted in a television receiver. FIG. 19 is a block diagram showing a configuration example of the television receiver 511 in which the above-described image processing apparatus is mounted with reference to FIG. 12.

The television receiver 511 of the same figure includes a controlled unit 531 and a control unit 532. The controlled unit 531 performs various functions of the television receiver 511 under the control of the control unit 532.

The controlled unit 531 includes a digital tuner 533, a demux 554, a Moving Picture Expert Group (MPEG) decoder 555, a video/graphic processing circuit 556, a panel driving circuit 557, a display panel 558, an audio processing circuit 559, an audio amplification circuit 560, a speaker 561, and a reception unit 562. The control unit 532 includes a Central Processing Unit 563, a flash ROM 564, a Dynamic Random Access Memory 565, and an internal bus 566.

The digital tuner 553 processes a television broadcast signal received from an antenna terminal (not shown) and supplies a predetermined Transport Stream (TS) corresponding to a channel selected by a user to the demux 554.

The demux 554 extracts a partial TS (TS packets of a video signal and TS packets of an audio signal) corresponding to the channel selected by the user from the TS supplied from the digital tuner 553 and supplies the TS to the MPEG decoder 555.

The demux 554 extracts Program Specific Information/Service Information (PSI/SI) from the TS supplied from the digital tuner 553 and supplies the PSI/SI to the CPU 563. A plurality of channels is multiplexed in the TS supplied from the digital tuner 553. The process of extracting the partial TS of a certain channel from the TS by the demux 554 is performed by obtaining the information about the packet ID (PID) of the certain channel from the PSI/SI (PAT/PMT).

The MPEG decoder 555 performs the decoding process with respect to video Packetized Elementary Stream (PES) packets configured by the TS packets of the video signal supplied from the demux 554 and supplies the video signal obtained as that result to the video/graphic processing circuit 556. The MPEG decoder 555 performs the decoding process with respect to audio PES packets configured by the TS packets of the audio signal supplied from the demux 554 and supplies the audio signal obtained as that result to the audio processing circuit 559.

The video/graphic processing circuit 556 performs a scaling process, a superposition process of graphics data or the like, if necessary, with respect to the video signal supplied from the MPEG decoder 555 and supplies the video signal to the panel driving circuit 557.

An image improving circuit 570 is connected to the video/graphic processing circuit 556 and the image quality improvement process is executed prior to the supply of the video signal to the panel driving circuit 557.

The image quality improving circuit 570 is configured similarly to the above-described image processing apparatus with reference to FIG. 12 and the discrimination regression prediction process described above with reference to FIG. 17 is executed as the image quality improvement process with respect to the image data obtained from the video signal supplied from the MPEG decoder 555.

The panel driving circuit 557 drives the display panel 558 based on the video signal supplied from the video/graphic processing circuit 556 and displays video. The display panel 558 includes, for example, a Liquid Crystal Display (LCD), a Plasma Display Panel (PDP) or the like.

The audio processing circuit 559 performs a necessary process such as a Digital-to-Analog (D/A) conversion with respect to the audio signal supplied from the MPEG decoder 555 and supplies the audio signal to the audio amplification circuit 560.

The audio amplification circuit 560 amplifies the analog audio signal supplied from the audio processing circuit 559 and supplies the audio signal to the speaker 561. The speaker 561 outputs audio according to the analog audio signal from the audio amplification circuit 560.

The reception unit 562 receives, for example, an infrared remote control signal transmitted from the remote controller 567 and supplies the infrared remote control signal to the CPU 563. The user manipulates the remote controller 567 so as to manipulate the television receiver 511.

The CPU 563, the flash ROM 564 and the DRAM 565 are connected through the internal bus 566. The CPU 563 controls the operations of the units of the television receiver 11. The flash ROM 564 performs control software storage and data keeping. The DRAM 565 configures a work area or the like of the CPU 563. That is, the CPU 563 develops software or data read from the flash ROM 564 on the DRAM 565, starts up the software, and controls the units of the television receiver 511.

In this way, it is possible to apply the present invention to the television receiver.

The above-described series of processes may be executed by hardware or software. If the series of processes is executed by software, a program configuring the software is installed in a computer, in which dedicated hardware is embedded, from a network or a recording medium. For example, various types of programs are installed in a general-purpose personal computer 700 shown in FIG. 20, which is capable of executing a variety of functions, from a network or a recording medium.

In FIG. 20, a Central Processing Unit (CPU) 701 executes a variety of processes according to a program stored in a Read Only Memory (ROM) 702 or a program loaded from a storage unit 708 to a Random Access Memory (RAM) 703. Data or the like necessary for executing a variety of processes by the CPU 701 is appropriately stored in the RAM 703.

The CPU 701, the ROM 702 and the RAM 703 are connected to each other via a bus 704. An input/output interface 705 is also connected to the bus 704.

An input unit 706 such as a keyboard or a mouse, a display such as a Liquid Crystal Display (LCD) and an output unit 707 such as a speaker is connected to the input/output interface 705. A storage unit 708 including a hard disk and a communication unit 709 including a modem or a network interface card such as a LAN card are connected to the input/output interface 705. The communication unit 709 performs a communication process over a network including the Internet.

A drive 710 is connected to the input/output interface 705 if necessary and a removable media 711 such as a magnetic disk, an optical disk, a magneto-optical disk or a semiconductor memory is appropriately mounted. A computer program read from the removable media is installed in the storage unit 708 if necessary.

If the above-described series of processes are executed by software, the program configuring the software is installed from the network such as the Internet or the recording medium including the removable media 711 or the like.

The recording medium includes the removable media 711 having a program recorded thereon, which is distributed in order to deliver the program to a user, including a magnetic disk (including a floppy disk (registered trademark)), an optical disk (including a Compact Disk-Read Only Memory (CD-ROM) and a Digital Versatile Disk (DVD)), a magneto-optical disk (including a Mini-Disk (MD) (registered trademark)), a semiconductor memory or the like, and includes a hard disk or the like included in the ROM 702 or the storage unit 708 having a program recorded thereon, which is delivered to the user in a state of being assembled in the main body of the apparatus in advance, separately from the main body of the apparatus shown in FIG. 20.

In the present specification, the above-described series of processes includes not only processes performed in time series in the described order or processes performed in parallel or individually.

The present embodiments of the present invention are not limited to the above-described embodiments and various modifications are made without departing from the scope of the present invention.

The present application contains subject matter related to that disclosed in Japanese Priority Patent Application JP 2010-081325 filed in the Japan Patent Office on Mar. 31, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A coefficient learning apparatus comprising:
a regression coefficient calculation means for acquiring a regression tap configured as a plurality of filter operation values for extracting a frequency band of a variation in pixel values of a target pixel and a peripheral pixel from an image of a first signal and calculating a regression coefficient of a regression prediction operation for obtaining the pixel value corresponding to the target pixel in an image of a second signal by an operation of the regression tap and the regression coefficient;
a regression prediction value calculation means for performing the regression prediction operation based on the calculated regression coefficient and the regression tap obtained from the image of the first signal and calculating a regression prediction value;
a discrimination information assigning means for assigning discrimination information for discriminating whether the target pixel belongs to a first discrimination class or a second discrimination class based on a result of comparing the calculated regression prediction value and the pixel value corresponding to the target pixel in the image of the second signal;
a discrimination coefficient calculation means for acquiring a discrimination tap including a plurality of feature amounts as elements based on the pixel value of the peripheral pixel and a plurality of filter operation values for extracting the frequency band of the variation in pixel values of the target pixel and the peripheral pixel from the image of the first signal based on the assigned discrimination information and calculating the discrimination coefficient of a discrimination prediction operation for obtaining a discrimination prediction value for specifying a discrimination class, to which the target pixel belongs, by a product-sum operation of each of the elements of the discrimination tap and the discrimination coefficient;
a discrimination prediction value calculation means for performing the discrimination prediction operation based on the discrimination tap obtained from the image of the first signal and the calculated discrimination coefficient and calculating a discrimination prediction value; and
a classification means for classifying the pixels of the image of the first signal into any one of the first discrimination class and the second discrimination class based on the calculated discrimination prediction value,
wherein the regression coefficient calculation means further calculates the regression coefficient using only the pixels classified into the first discrimination class and calculates the regression coefficient using only the pixels classified into the second discrimination class.

2. The coefficient learning apparatus according to claim 1, wherein a process of assigning the discrimination information by the discrimination information assigning means, a process of calculating the discrimination coefficient by the discrimination coefficient calculation means and a process of calculating the discrimination prediction value by the discrimination prediction value calculation means are repeatedly executed based on the regression prediction value calculated for each discrimination class by the regression prediction value calculation means and by the regression coefficient calculated for each discrimination class by the regression coefficient calculation means.

3. The coefficient learning apparatus according to claim 1, wherein:
if a difference between the regression prediction value and the pixel value corresponding to the target pixel in the image of the second signal is equal to or greater than 0, it is determined that the target pixel belongs to the first discrimination class, and
if the difference between the regression prediction value and the pixel value corresponding to the target pixel in the image of the second signal is less than 0, it is determined that the target pixel belongs to the first discrimination class.

4. The coefficient learning apparatus according to claim 1, wherein:
if an absolute value of a difference between the regression prediction value and the pixel value corresponding to the target pixel in the image of the second signal is equal to or greater than a predetermined threshold value, it is determined that the target pixel belongs to the first discrimination class, and
if the absolute value of the difference between the regression prediction value and the pixel value corresponding to the target pixel in the image of the second signal is less than a predetermined threshold value, it is determined that the target pixel belongs to the second discrimination class.

5. The coefficient learning apparatus according to claim 1, wherein the image of the first signal is an image in which the frequency band of the variation in pixel value is limited and predetermined noise is applied to the image of the second signal.

6. The coefficient learning apparatus according to claim 5, wherein the image of the second signal is a natural image or an artificial image.

7. The coefficient learning apparatus according to claim 1, wherein the plurality of feature amounts based on the pixel value of the peripheral pixel included in the discrimination tap are a maximum value of a peripheral pixel value, a minimum value of a peripheral pixel value and a maximum value of a difference absolute value of a peripheral pixel value.

8. A coefficient learning method comprising the steps of:
causing a regression coefficient calculation means to acquire a regression tap configured as a plurality of filter operation values for extracting a frequency band of a variation in pixel values of a target pixel and a peripheral pixel from an image of a first signal and to calculate a regression coefficient of a regression prediction operation for obtaining the pixel value corresponding to the target pixel in an image of a second signal by an operation of the regression tap and the regression coefficient;
causing a regression prediction value calculation means to perform the regression prediction operation based on the calculated regression coefficient and the regression tap obtained from the image of the first signal and to calculate a regression prediction value;
causing a discrimination information assigning means to assign discrimination information for discriminating whether the target pixel belongs to a first discrimination class or a second discrimination class based on a result of comparing the calculated regression prediction value and the pixel value corresponding to the target pixel in the image of the second signal;
causing a discrimination coefficient calculation means to acquire a discrimination tap including a plurality of feature amounts as elements based on the pixel value of the peripheral pixel and a plurality of filter operation values for extracting the frequency band of the variation in pixel values of the target pixel and the peripheral pixel from the image of the first signal based on the assigned discrimination information and calculating the discrimination coefficient of a discrimination prediction operation for obtaining a discrimination prediction value for specifying a discrimination class, to which the target pixel belongs, by a product-sum operation of each of the elements of the discrimination tap and the discrimination coefficient;
causing a discrimination prediction value calculation means to perform the discrimination prediction operation based on the discrimination tap obtained from the image of the first signal and the calculated discrimination coefficient and to calculate a discrimination prediction value; and
causing a classification means to classify the pixels of the image of the first signal into any one of the first discrimination class and the second discrimination class based on the calculated discrimination prediction value, and
further calculating the regression coefficient using only the pixels classified into the first discrimination class and calculating the regression coefficient using only the pixels classified into the second discrimination class.

9. A program for causing a computer to function as a coefficient learning apparatus comprising:
a regression coefficient calculation means for acquiring a regression tap configured as a plurality of filter operation values for extracting a frequency band of a variation in pixel values of a target pixel and a peripheral pixel from an image of a first signal and calculating a regression coefficient of a regression prediction operation for obtaining the pixel value corresponding to the target pixel in an image of a second signal by an operation of the regression tap and the regression coefficient;
a regression prediction value calculation means for performing the regression prediction operation based on the calculated regression coefficient and the regression tap obtained from the image of the first signal and calculating a regression prediction value;
a discrimination information assigning means for assigning discrimination information for discriminating whether the target pixel belongs to a first discrimination class or a second discrimination class based on a result of comparing the calculated regression prediction value and the pixel value corresponding to the target pixel in the image of the second signal;
a discrimination coefficient calculation means for acquiring a discrimination tap including a plurality of feature amounts as elements based on the pixel value of the peripheral pixel and a plurality of filter operation values for extracting the frequency band of the variation in pixel values of the target pixel and the peripheral pixel from the image of the first signal based on the assigned discrimination information and calculating the discrimination coefficient of a discrimination prediction operation for obtaining a discrimination prediction value for specifying a discrimination class, to which the target pixel belongs, by a product-sum operation of each of the elements of the discrimination tap and the discrimination coefficient;
a discrimination prediction value calculation means for performing the discrimination prediction operation based on the discrimination tap obtained from the image of the first signal and the calculated discrimination coefficient and calculating a discrimination prediction value; and
a classification means for classifying the pixels of the image of the first signal into any one of the first discrimination class and the second discrimination class based on the calculated discrimination prediction value,
wherein the regression coefficient calculation means further calculates the regression coefficient using only the pixels classified into the first discrimination class and calculates the regression coefficient using only the pixels classified into the second discrimination class.

10. An image processing apparatus comprising:
a discrimination prediction means for acquiring a regression tap including a plurality of feature amounts as elements based on a plurality of filter operation values for extracting a frequency band of a variation in pixel values of a target pixel and a peripheral pixel from an image of a first signal and the pixel value of the peripheral pixel and performing a discrimination prediction operation for obtaining a discrimination prediction value for specifying a discrimination class to which the target pixel belongs by a product-sum operation of each of the elements of the discrimination tap and the discrimination coefficient;
a classification means for classifying the pixels of the image of the first signal into any one of the first discrimination class and the second discrimination class based on the discrimination prediction value; and
a regression prediction means for acquiring a regression tap configured as the plurality of filter operation values for extracting the frequency band of the variation in pixel values of the target pixel and the peripheral pixel from the image of the first signal and calculating a regression prediction value by an operation of the regression tap and a regression coefficient so as to predict the pixel value of the pixel corresponding to the target pixel in an image of a second signal.

11. The image processing apparatus according to claim 10, wherein a process of performing the discrimination prediction operation by the discrimination prediction means and a process of classifying the pixels of the image of the first signal by the classification are repeatedly executed.

12. The image processing apparatus according to claim 10, wherein the image of the first signal is an image in which the frequency band of the variation in pixel value is limited and predetermined noise is applied to the image of the second signal.

13. The image processing apparatus according to claim 12, wherein the image of the second signal is a natural image or an artificial image.

14. The image processing apparatus according to claim 10, wherein the plurality of feature amounts based on the pixel value of the peripheral pixel included in the discrimination tap are a maximum value of a peripheral pixel value, a minimum value of a peripheral pixel value and a maximum value of a difference absolute value of a peripheral pixel value.

15. An image processing method comprising the steps of: causing a discrimination prediction means to acquire a regression tap including a plurality of feature amounts as elements based on a plurality of filter operation values for extracting a frequency band of a variation in pixel values of a target pixel and a peripheral pixel from an image of a first signal and the pixel value of the peripheral pixel and to perform a discrimination prediction operation for obtaining a discrimination prediction value for specifying a discrimination class to which the target pixel belongs by a product-sum operation of each of the elements of the discrimination tap and the discrimination coefficient;
causing a classification means to classify the pixels of the image of the first signal into any one of the first discrimination class and the second discrimination class based on the discrimination prediction value; and
causing a regression prediction means to acquire a regression tap configured as the plurality of filter operation values for extracting the frequency band of the variation in pixel values of the target pixel and the peripheral pixel from the image of the first signal and to calculate a regression prediction value by an operation of the regression tap and a regression coefficient so as to predict the pixel value of the pixel corresponding to the target pixel in an image of a second signal.

16. A program for causing a computer to function as an image processing apparatus comprising:
a discrimination prediction means for acquiring a regression tap including a plurality of feature amounts as elements based on a plurality of filter operation values for extracting a frequency band of a variation in pixel values of a target pixel and a peripheral pixel from an image of a first signal and the pixel value of the peripheral pixel and performing a discrimination prediction operation for obtaining a discrimination prediction value for specifying a discrimination class to which the target pixel belongs by a product-sum operation of each of the elements of the discrimination tap and the discrimination coefficient;
a classification means for classifying the pixels of the image of the first signal into any one of the first discrimination class and the second discrimination class based on the discrimination prediction value; and
a regression prediction means for acquiring a regression tap configured as the plurality of filter operation values for extracting the frequency band of the variation in pixel values of the target pixel and the peripheral pixel from the image of the first signal and calculating a regression prediction value by an operation of the regression tap and a regression coefficient so as to predict the pixel value of the pixel corresponding to the target pixel in an image of a second signal.

17. A recording medium having the program according to claim 9 or 16 recorded thereon.

18. A coefficient learning apparatus comprising:
a regression coefficient calculation unit configured to acquire a regression tap configured as a plurality of filter operation values for extracting a frequency band of a variation in pixel values of a target pixel and a peripheral pixel from an image of a first signal and calculate a regression coefficient of a regression prediction operation for obtaining the pixel value corresponding to the target pixel in an image of a second signal by an operation of the regression tap and the regression coefficient;
a regression prediction value calculation unit configured to perform the regression prediction operation based on the calculated regression coefficient and the regression tap obtained from the image of the first signal and calculate a regression prediction value;
a discrimination information assigning configured to assign discrimination information for discriminating whether the target pixel belongs to a first discrimination class or a second discrimination class based on a result of comparing the calculated regression prediction value and the pixel value corresponding to the target pixel in the image of the second signal;
a discrimination coefficient calculation unit configured to acquire a discrimination tap including a plurality of feature amounts as elements based on the pixel value of the peripheral pixel and a plurality of filter operation values for extracting the frequency band of the variation in pixel values of the target pixel and the peripheral pixel from the image of the first signal based on the assigned discrimination information and calculate the discrimination coefficient of a discrimination prediction operation for obtaining a discrimination prediction value for specifying a discrimination class, to which the target pixel belongs, by a product-sum operation of each of the elements of the discrimination tap and the discrimination coefficient;
a discrimination prediction value calculation unit configured to perform the discrimination prediction operation based on the discrimination tap obtained from the image of the first signal and the calculated discrimination coefficient and calculate a discrimination prediction value; and
a classification unit configured to classify the pixels of the image of the first signal into any one of the first discrimination class and the second discrimination class based on the calculated discrimination prediction value,
wherein the regression coefficient calculation unit further calculates the regression coefficient using only the pixels classified into the first discrimination class and calculates the regression coefficient using only the pixels classified into the second discrimination class.
